(19) United States
(12) Patent Application Publication
(10) Pub. No.: US 2015/0299380 A1
(43) Pub. Date: Oct. 22, 2015

(54) SOLUBLE POLYMERS

(71) Applicant: THE UNIVERSITY OF LIVERPOOL, Liverpool, Merseyside (GB)

(72) Inventors: Andrew Cooper, Chesire (GB); David Adams, Bebington (GB); Ge Cheng, Liverpool (GB); Tom Hasell, Liverpool (GB)

(73) Assignee: The University of Liverpool, Liverpool, Merseyside (GB)

(21) Appl. No.: 14/440,353

(22) PCT Filed: Nov. 4, 2013
(86) PCT No.: PCT/GB2013/052878

§ 371 Date: May 2, 2015

(30) Foreign Application Priority Data
Nov. 2, 2012 (GB) 1219783.6

(51) Int. Cl. C08G 61/10; H01G 11/04; B01J 31/06; H01M 2/16; C08J 9/00; C08J 5/18

(52) U.S. Cl. CPC C08G 61/10; C08J 9/00; C08J 5/18; B01J 31/063; H01M 2/1653; H01G 11/04; C08J 2365/00; C08J 2205/044; C08G 2261/11; C08G 2261/12; C08G 2261/18; C08G 2261/314; C08G 2261/64; C08G 2261/1428; C08G 2261/132

(57) ABSTRACT

Polymers exhibiting solubility, conjugation and microporosity are processable and useful for a variety of applications. The polymers comprise repeating units which are linked together to form rigid macromolecular structures which do not exhibit space-efficient packing. The polymers may comprise aromatic structures, e.g. fused aromatic structures and/or multiply bonded aromatic structures, and may comprise solubilising groups such as for example branched alkyl groups or siliyl groups.

The present invention relates to soluble polymers.

Some of our earlier work in relation to conjugated microporous polymers (CMPs) is described in WO 2009/022187. That document related to the linking of aryl and alkyne units to form insoluble conjugated microporous poly(aryleneethynylene) networks.

In the last five years, conjugated microporous polymers (CMPs)^{[1]} and other insoluble polymer networks formed by carbon-carbon coupling chemistry^{[2]} have emerged as an important platform in amorphous porous materials. CMPs are the first synthetic networks to combine permanent microporosity (pores <2 nm) with extended pi-conjugation. Building on reports of tunable pore sizes,^{[1a,1c]} structural modularity,^{[1e]} record surface areas (5000-6500 m²/g),^{[2b,2c]} and exceptional physicochemical stability,^{[2b]} new materials have been developed for applications such as catalysis,^{[1h,1i,2c]} light harvesting,^{[1g]} carbon dioxide capture,^{[1k,2d]} superhydrophobic separations,^{[1m]} luminescence,^{[1l]} sensors,^{[1n]} and supercapacitors.^{[1j]} All of these materials are insoluble networks. This insolubility limits the range of processing options for some of the more interesting applications of CMPs that seek to exploit the unique combination of porosity, conjugation, and synthetic diversity.

Unlike CMP networks, some other porous polymers are solution processable. In particular, rigid and contorted “polymers of intrinsic microporosity” (PIMs)^{[3]} can be dissolved in organic solvents and fabricated, for example, into microporous membranes.^{[3-4]} To date, however, soluble linear PIMs have been prepared by condensation chemistry that introduces heteroatoms into the polymer chain and that does not introduce extended pi-conjugation.

Dispersible CMP nanoparticles have been formed by emulsion techniques,^{[5]} but there has hitherto been no disclosure of solubility in relation to solid-state CMPs. In particular, heterogenous nanoparticulate dispersions may be unsuitable for applications that require true solubility, such as the formation of polymeric films and coatings. This is because the structure of the materials does not allow the formation of continuous uniform products. Moreover, dispersions unlike solutions often require additional stabilizing agents such as surfactants which add cost and complexity, and interfere with the final desired application of the materials. The emulsion-formed materials contain other components and therefore do not allow the formation of homogenous films.

The prior art teaches that it is not possible to have porosity in CMPs in combination with solubility. For example, one review article on porous polymers^{[6a]} states: “If on one hand the porosity and high surface areas pose great advantages for these materials, on the other hand this comes at a cost in terms of solubility and ultimately proccessability. In general and with the exception of PIMs, these materials once made are insoluble and therefore difficult to apply”. Another review article^{[6b]} states that the “conjugated structure [of CMPs] could result in them exhibiting valuable physical functions, for example in organic electronic devices” but also recognizes that this requires the materials to be produced as thin films, a synthetic challenge which has hitherto not been overcome.

We have now discovered that solubility can be combined with microporosity in the field of conjugated polymers, and that the resultant materials have highly advantageous properties in view of their processability.

From a first aspect, the present invention provides a soluble conjugated microporous polymer.

This simple definition captures the essence of the invention. The presence of solubility in conjugated microporous polymers has not previously been reported. Solubility, conjugation, and microporosity are important features from a practical perspective, and each will now be discussed in turn.

In the context of soluble conjugated microporous polymers, the skilled person in the polymer chemistry field understands “soluble” to mean that the material is soluble to a practically useful extent. For example, the material is soluble such that it can be processed into thin films. It dissolves in solvent to form a single-phase solution, as opposed to a two phase dispersion or emulsion where the polymer would be present as a second solid or liquid phase. The solvent may be an organic solvent.

Advantageously, the polymers of the present invention can be solution-processed. For example, a solution casting method can be used to prepare films, or precipitation from solution can provide powders.

The term “soluble” may also be understood to mean “processable”. Solubility opens up a large range of processing options that are not applicable to insoluble materials. For example, it allows the preparation of mixed materials by co-dissolving the polymer with other materials that are soluble in the same solvent. It facilitates easy casting, coating, mixing, extrusion, spin-coating, electrospinning, precipitation, and other processes. This processability is not a feature of insoluble particulate porous networks, which may be simply mixed together as dry powders, but not coprocessed in solution the manner described above.

The polymer is conjugated in the sense that extended pi conjugation is present from one monomer to the next. In other words the conjugation is present not just within monomers but also between monomers. For example, if one imagines a monomer somewhere in the centre of the polymer, then conjugation will extend from an adjacent monomer through the central monomer and out to other adjacent monomers. The precise degree of conjugation will depend on the specific monomer chemistry, and potentially the structure—for example, the dihedral angle between neighbouring aryl groups. However, conjugated polymers can be distinguished, broadly, from non-conjugated polymers in terms of the scope for extended pi conjugation in the chain, which is absent in non-conjugated polymers. As such, the meaning of the term “conjugated polymer” would be clear to one skilled in the art, notwithstanding that the exact degree of conjugation, and related physical properties such as conductivity, can vary significantly from one conjugated material to another.

The term “microporous” takes its normal meaning as understood by one skilled in the art. Typically, microporous materials have pore sizes smaller than 2 nm. Preferably the materials have a non-zero B.E.T. surface area value, typically at least 10 m²/g, e.g. at least 100 m²/g. Some materials may not he porous to nitrogen gas at a temperature of 77 K (the most common probe gas/temperature combination used to calculated B.E.T. surface areas), but may nonetheless be porous to other gases, such as CO₂, at higher temperatures because of enhanced molecular mobilities. Materials that adsorb large quantities of such gases in molecular size pores (<2 nm) may also be considered as microporous, even if the nitrogen B.E.T. surface area is low. As such, a more general definition of a microporous material is one where the pores are mostly smaller than 2 nm, and where a practically significant quantity of gas is adsorbed—for example, with respect to technical processes such as gas separation, removal of contaminants (e.g., activated carbon is a well known insoluble microporous material), or heterogeneous catalysis, where large surface areas may be desirable to promote a particular chemical reaction. This practical concept of microporosity, that is small pores combined with substantial surface areas, is clear to one skilled in the art.

In the case of soluble conjugated microporous polymers, the porosity arises from inefficient molecular packing coupled with molecular rigidity such that the porous structure is stable within the material. That is, the polymer chains pack inefficiently to leave spaces—the pores—because the polymer chains are of a shape and conformation such that they cannot readily pack in an efficient manner to fill space, which is typically the thermodynamically preferred form for a polymeric solid. The feature of molecular rigidity is necessary because a more flexible polymer chain would be able to adopt a different conformation, or shape, thus allowing a denser, nonporous molecular packing to occur. Hence, both rigidity and shape are important in producing microporosity since neither a ‘poorly packing’ molecular shape nor molecular rigidity is, by itself, sufficient to produce microporosity. To give two examples, there are many highly branched or dendritic polymers that are well known in the art, such as polypropylene imine dendrimers, that have complex, branched architectures. These materials are nonporous because they are flexible in nature, and can therefore can adopt molecular conformations that pack efficiently in the solid state. Conversely, certain linear polymers, such as many linear polyphenylenes, are highly rigid and inflexible, but are nonetheless nonporous because the chains have a shape or conformation that can pack efficiently in the solid state, sometimes by forming ordered crystalline domains.

Therefore, from a further aspect, the present invention can be understood as providing a soluble conjugated microporous polymer wherein the microporosity arises from voids between the repeating units within the polymer chain, as a result of a suitable combination of shape and molecular rigidity. This inefficient packing may be referred to as inherent or intrinsic porosity. In other words, the present invention provides a soluble conjugated microporous polymer comprising repeating units that are linked together to form a rigid macromolecular structure that does not exhibit space-efficient packing. Thus the molecular structure may exhibit, for example, a rigid twisted or contorted structure which, unlike the linear polyphenylene example referred to above, generates voids or pores.

The macromolecular structure of the polymer may contain moieties which are one, more, or all of: rigid; twisted; contorted; concave; large; bulky; or moieties which impart intrinsic porosity. The invention as defined herein refers to moieties: this may either be the repeating presence of one moiety, or two or more different kinds of moiety.

The growth of the polymer may be restricted in order to bring about and/or enhance solubility; for example, by carrying out the reaction under conditions of concentration, monomer stoichiometry, reaction temperature, and reaction time where branched polymers or oligomers are formed rather than extended, insoluble networks. Another method for controlling molecular weight is to include at least some monomers that are divalent (rather than having a higher valency), so that branching does not occur at the said monomers.

Therefore from this aspect the present invention provides a conjugated microporous polymer in the form of discrete soluble polymer units.

Features may be present or introduced to solubilize the polymer chains.

Surprisingly, neither the relatively low molecular weight of restricted-growth materials, nor the introduction of solubilizing groups, such as alkyl groups, renders these materials non-porous.

The polymer may have a solubility of 0.05 g/mL in an organic solvent preferably 0.2 g/mL, or more preferably 1 g/mL in an organic solvent.

Suitable organic solvents include, for example, chloroform, dichloromethane, hexane, pentane, benzene, toluene, xylene, dimethylformamide, dimethylsulfoxide, ethyl acetate, petroleum ether, diethyl ether, tetrahydrofuran, perfluorooctane, acetonitrile, ethanol, methanol, butanol, cyclohexane, dioxane, dichloroethane acetic acid, methyl ethyl ketone, acetone, propanol, and iso-propanol. The classes of solvents may for example be alcohols, hydrocarbons (aliphatic or aromatic), halogenated solvents, esters, ethers, ketones, polar solvents, nonpolar solvents, or other classes of solvents. In some embodiments, for example with pyrene-containing polymers, dichloromethane, chloroform or tetrahydrofuran (particularly dichloromethane or tetrahydrofuran) are particularly suitable, though this depends on the type or polymer and other types of solvent are more suitable for other types of polymer. A key consideration is to allow processability and the appropriate solvent-polymer combination will be compatible with that requirement. The solvent may be one of the solvents, or a combination of solvents.

Likewise, the polymer may have a solubility in water in the same general ranges if hydrophilic solubilizing groups are used.

One or more solubilizing group may be used on one or more monomer to impart solubility characteristics to the resultant polymer. For example one solubilizing group may be present on one of the monomers so that solubilizing groups occur in the polymer as often as said monomer appears in the polymer.

The solubilizing groups required will depend on the solvent that is targeted (e.g., organic solvent or water), and may be selected from alkyl chains (linear or branched), fluoroalkyl chains, silyl groups, alkyl ethers, oligoethyleneoxide, oligopropylene oxide, carboxylic acid groups, sulfonates, quaternary ammonium salts, imidizolium salts, pyridinium salts or other suitable groups known in the art.

For solubility in organic solvents alkyl chains, or moieties containing alkyl chains, are preferred solubilizing groups. These may optionally be substituted and/or may optionally be unsaturated, so that they may for example contain alkene or alkyne parts. Branched alkyl chains such as for example tert-butyl work particularly well. It is possible that these groups work well because their structure avoids interpenetration which could adversely affect porosity. Whilst tertiary butyl groups have been found to be particularly effective, and are easy to incorporate, other branched alkyl chains can be used as solubilizing groups, e.g. up to C10 branched alkyl, e.g. up to C8 branched alkyl, e.g. up to C6 branched alkyl.

Silyl groups, e.g. TMS groups, are also preferred solubilizing groups.

The polymer may be microporous to the extent of having a micropore volume of around 0.1 cm³/g, more preferably a micropore volume of 0.3 cm³/g, or most preferably a micropore volume of 0.6 cm³/g or greater. It should be noted however that higher micropore volumes are not always more desirable for all applications, and that in some applications, such as gas separation, smaller pore volumes and smaller diameter pores may be desired to allow the diffusion of one gas in preference to another.

The materials of the present invention comprise discrete molecules rather than extended networks. Extended networks are sometimes described as “infinite” though it is more accurate to describe them as sufficiently extended such that the molecular weight is defined by the mass of the entity; thus a particle of an extended network comprises in principle one extremely large molecule. In contrast, a particle of the soluble material of the present invention comprises many discrete polymer chains. Because a network is a material that cannot disaggregate, it is insoluble. In contrast the polymers of the present invention are soluble in common solvents.

Conjugated microporous polymers are generally understood in the field to be different to dendrimers, although some dendrimers may also be conjugated. The former are prepared by statistical polymerisation to produce complex irregular amorphous materials, whereas the latter are prepared by very controlled reaction and isolation sequences to produce materials with a defined molecular weight. Therefore the soluble conjugated microporous polymers of the present invention do not include dendrimers.

Without wishing to be bound by theory, the structural origin of microporosity is believed to rely upon rigidity combined with non-interpenetrating cavities.

Hyperbranching is used to ensure a structure with three-dimensional microporosity combined with solubility.

From a former aspect the present invention provides a microporous polymer comprising nodes and struts in conjugation with each other, wherein
the nodes comprise one or more of an aromatic moiety and an unsaturated moiety,
the struts comprise one or more of a single bond, an unsaturated moiety, and an aromatic moiety,
the polymer carries one or more solubilizing group.

This definition is another way of understanding the present invention; the features described above are applicable to and combinable with this definition.

The nodes are connected to each other via struts. The overall effect is to have an extended pi-conjugated material containing aromatic and/or unsaturated parts. The struts may simply be single bonds linking together adjacent nodes. Alternatively, the struts or some of them may themselves contain unsaturated and/or aromatic units.

“Aromatic” is to be understood in a broad sense, namely encompassing heteroaromatic.

It is important to note that the materials of the present invention may contain more than one different type of node and more than one different type of strut. In other words the products are not necessarily homopolymers but may contain different types of monomers and different types of linking structure. This provides further advantages. One particular component in a multicomponent mixture may be varied in order to tune the properties of the final product.

Furthermore, the fact that the polymers are the statistical products of monomers (including mixtures of monomers) rather than having a specified make-up brings advantages in terms of ease of preparation in comparison to dendrimers and PIMs,

The polymer may comprise aromatic, heteroaromatic, or aryleneethynylene building blocks. These monomers may he coupled together by any suitable chemistry that can give the target structure such as metal-catalyzed coupling or cross-coupling chemistry, acid catalysed cyclotrimerization, or other chemistry known in the art to produce conjugated polymer structures.

Advantageously, a method which does not involve metal catalysis may be utilized to prepare the polymers of the present invention. This can bring advantages in terms of cost, and can simplify the process, be more environmentally friendly and reduce disposal requirements. For example the polymers may be made using a Diels-Alder reaction step.

The polymer may he in the form of a film.

The polymer may comprise monomers or moieties which are benzene rings or fused structures containing multiple phenyl rings, for example naphthalene, phenanthrene, anthracene, tetracene, pentaphene, etc. The polymer may comprise multiple fused aromatic or heteroaromatic ring structures. Suitable fused heteroaromatic structures include for example carbazole.

Fused aromatic or heteroaromatic rings, linked via several positions to adjacent structures, are believed to be particularly effective in exhibiting porosity due to the way in which the macromolecular structure exhibits inefficient packing and therefore allows permanent void structures.

For example, the polymer may comprise pyrene monomers or pyrene moieties where at least some of the pyrene monomers or moieties carry solubilizing groups.

As noted above, more than one type of moiety may be present in the polymer structure. The polymer may be a copolymer. Therefore, for example, the polymer may contain only pyrene units, or may contain pyrene units in combination with other structures.

The structure of pyrene is as follows:

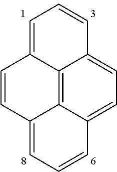 [SMILES: c1cc2ccc3cccc4ccc(c1)c2c34]

The carbon atoms at any of positions 1 to 10 may carry substituents or may be bonded to other moieties. For example, the pyrene monomers may be polymerized by aryl-aryl coupling so that single bonds connect pyrene moieties to each other. In this way, pyrene moieties act as nodes and single bonds act as struts. Alternatively, longer struts may be present (e.g. struts containing alkyne linkages). In one embodiment, aryl-aryl coupling may take place at some or all of positions 1, 3, 6 and 8, though other coupling positions and degrees are possible.

Solubilizing substituents are present on the pyrene moieties. In one embodiment, these may be present at the 2-position and/or the 7-position, preferably the 2-position, though other positions are possible.

Possible solubilizing substituents include alkyl substituents, for example C₁₋₈ alkyl chains. These are preferably branched chains, for example tert-butyl.

For example the polymer may comprise pyrene moieties carrying a solubilizing substituent in the 2-position and linked to adjacent pyrene moieties via the 6- and 8-positions. The repeating unit, where the solubilizing substituent is tert-butyl, could then be represented as follows:

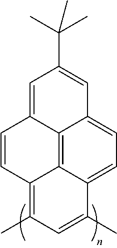

Optionally, as well as comprising such moieties, the polymer may also comprise other pyrene moieties which do not carry solubilizing groups. For example the latter may be unsubstituted pyrene moieties linked at some or all of the 1, 3, 6 and 8 positions. In other words the polymer may be a copolymer comprising the following:

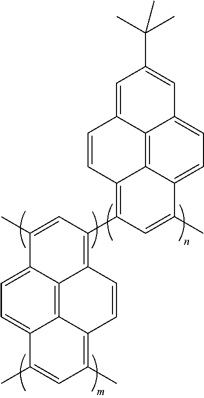

From a further aspect the present invention provides a method for preparing a soluble conjugated microporous polymer comprising polymerization or copolymerization of monomers, for example by aryl-aryl polymerization or copolymerization, for example using Suzuki coupling methodology.

One possible method comprises a pre-polymerization step followed by a polymerization step. For example, the method may comprise a first step of generating aryl boronates from corresponding aryl halides, followed by a second step of polymerizing the aryl boronate species. Advantageously the two steps may be carried out in a one-pot procedure.

The aryl halides may be aryl bromides, or other halides such as for example iodides.

The process may be carried out using Suzuki cross-coupling chemistry. Thus a palladium catalyst, for example palladium acetate, may be used to catalyze the aryl halide/diboron coupling, in the presence of for example bis(pinacolato)diboron, in the prepolymerization reaction step. Statistical, polymerization (or copolymerization in the case of more than one type of monomer being present) of for example Pd(Ph₃)₄ and base (for example potassium carbonate) may then be carried out to provide the polymer.

The skilled person understands that the reagents used may he varied in accordance with known coupling chemistry. For example, other boron complexes, other catalysts and other bases may be used.

As discussed above, processes which do not involve metal catalysis, e.g. Diels-Alder reactions, can be useful to prepare the polymers of the present invention. Such reactions can for example he used for polymers which contain pyrene moieties, as well as other moieties, as exemplified below.

Optionally, as exemplified below, the polymer may comprise benzene rings or other aromatic moieties which are linked to each other by single bonds. Such structures include polyphenylenes. Optionally the polymer may be such that it contains benzene or other aromatic rings which are directly bonded to one or more (e.g. two or more, e.g. three or more, e.g. four or more, e.g. five or more, e.g. six) other benzene or other aromatic rings. In other words, the polymer may comprise aromatic rings (e.g. benzene rings) which are multiply substituted with other aromatic rings (e.g. benzene rings). Large and bulky structures effected by such multiple substitution or linking of multiple aromatic moieties are believed to help avoid effective packing and thereby provide porosity. The benzene rings themselves can also provide a solubilizing effect.

While the materials of the present invention are typically microporous, in some cases the porosity may be low in magnitude, or selective. For example, some of the materials formed by solution casting are films which are porous to hydrogen but nonporous to nitrogen. This could be beneficial, for example, in applications such as gas separation. For some certain applications, the magnitude of the microporosity is less important, for example in applications concerned with electronic properties and/or concerned with selective porosity or non-porosity to some gases.

Therefore, from a further aspect the present invention provides polymers as defined above which have low but practically useful levels of microporosity.

With regard to the measurement of B.E.T. surface area values, samples were degassed for a minimum of 16 h at 120° C. prior to being measured. Ultrahigh purity gases were used for all measurements and the free volume was measured using helium. Nitrogen isotherms were collected either on a Micromertics ASAP 2020 or 2420 at 77 K. BET surface areas were calculated over the pressure range P/P₀=0.01-0.1.

With regard to the micropore volume, the pore volume at P/P₀=0.1 gives a good approximation of the micropore volume (V0.1), as described previously in Dawson, R.; Laybourn, A.; Clowes, R.; Khimyak, Y. Z.; Adams, D. J.; Cooper, A. I. Macromolecules 2009, 42, 8809.

The present invention is now described in further non-limiting detail with reference to the following examples and figures in which:

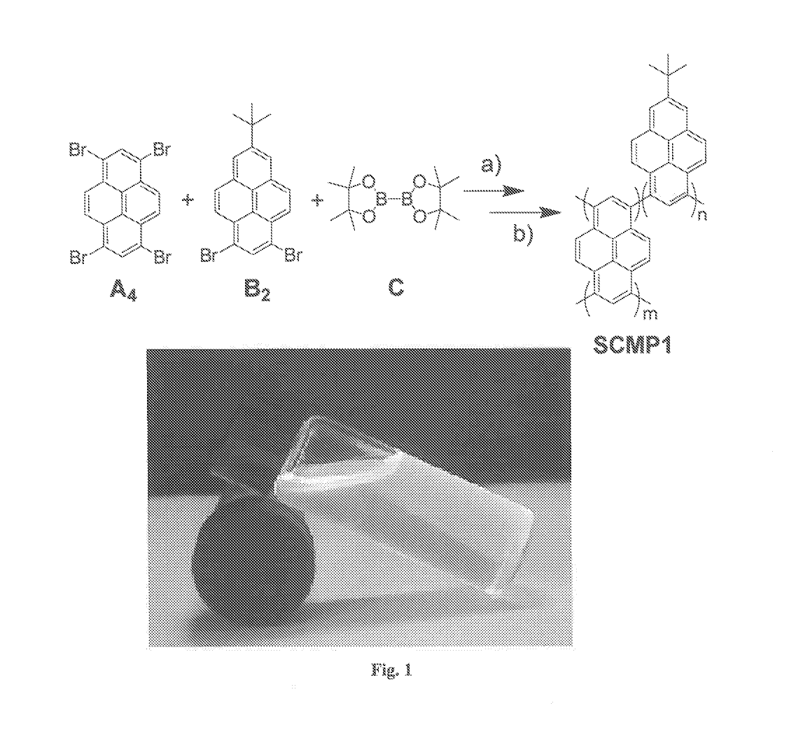

FIG. 1 shows a two-step, one-pot synthesis of a soluble conjugated microporous polymer, SCMP1. The resulting material is a statistical hyperbranched copolymer that is soluble in common organic solvents. A solution of SCMP1 in THF shows green luminescence under UV irradiation (λ=254 nm; image below the scheme). Reagents and conditions: a) bis(pinacolato)diboron, Pd(OAc)₂, KOAc, anhydrous DMF, 90° C.; b) Pd(PPh₃)₄, K₂CO₃, anhydrous DMF, 110° C.

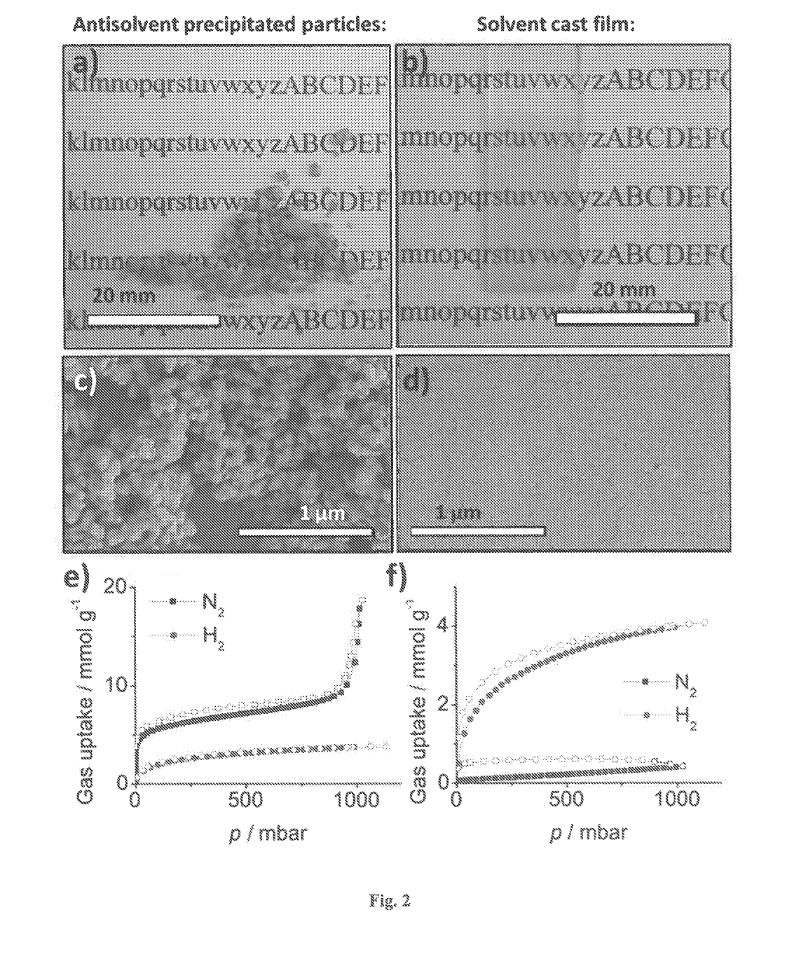

FIG. 2a) is a photograph of antisolvent precipitated SCMP1 powder.

FIG. 2b) is a photograph of a SCMP1 film prepared by slow evaporation.

FIG. 2c) is an SEM image showing fused nanospheres in the precipitated polymer.

FIG. 2d) is an SEM image showing the smooth surface of a cast SCMP1 film.

FIG. 2e) shows gas sorption isotherms for the precipitated powder, measured at 77 K, for nitrogen (squares) and hydrogen (circles); desorption curves shown as open symbols.

FIG. 2f) shows equivalent gas sorption isotherms for the solvent evaporated film; note different vertical scale in (e) and (f).

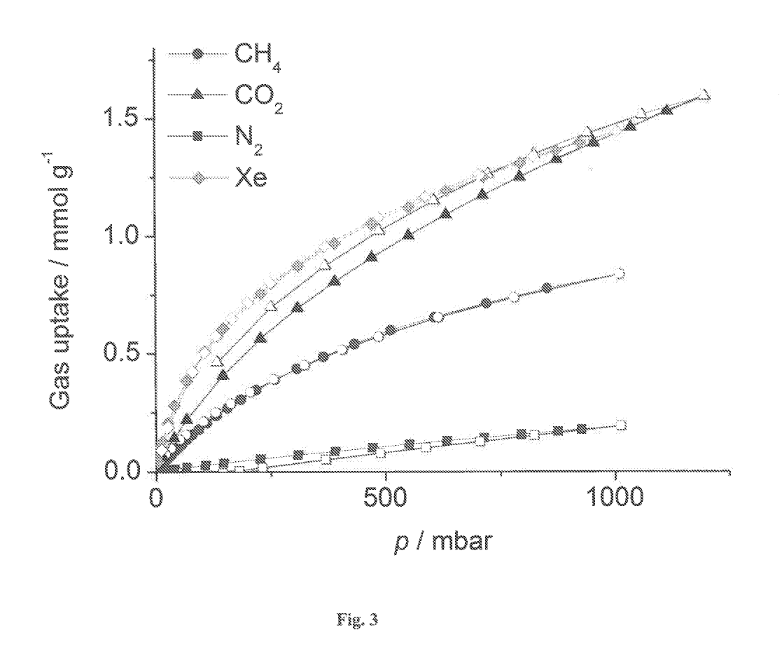

FIG. 3 shows nitrogen, methane, xenon, and carbon dioxide isotherms, recorded at 273 K, for DCM-cast SCMP1 films. Adsorption/desorption curves are shown as closed/open symbols, respectively.

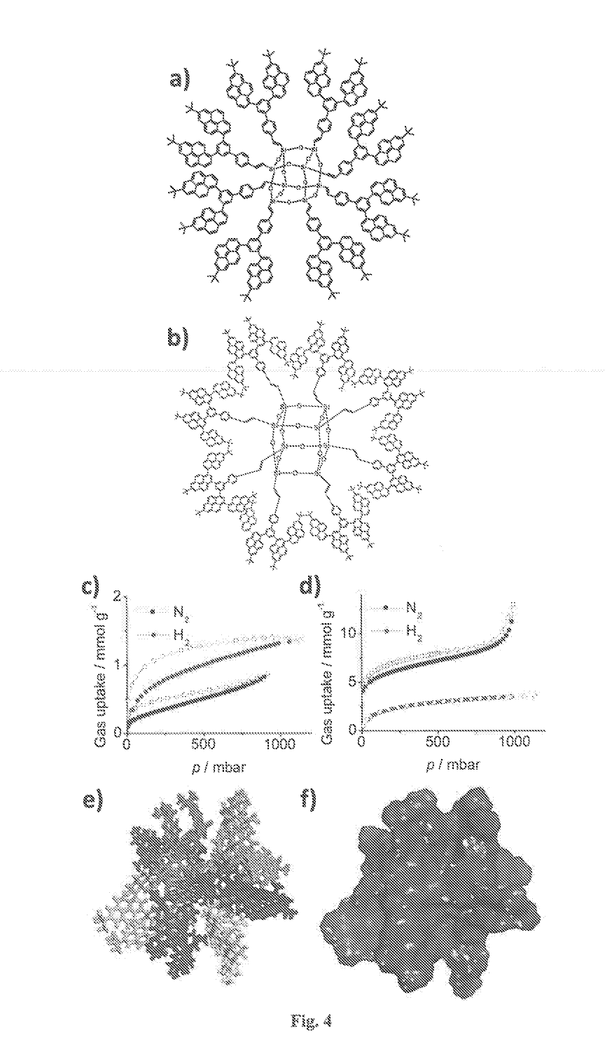

FIG. 4a) shows the structure of POSS-dend-1.

FIG. 4b) shows the structure of POSS-dend-2, with additional bulky groups shown.

FIG. 4c) shows nitrogen and hydrogen isotherms, measured at 77 K, for POSS-dend-1.

FIG. 4d) shows comparable nitrogen and hydrogen isotherms for POSS-dend-2; note different vertical scale in (c) and (d).

FIG. 4e) shows a molecular model for POSS-end-2.

FIG. 4f) is a representation of a model with Connolly surface shown, probe radius=1.82 Å.

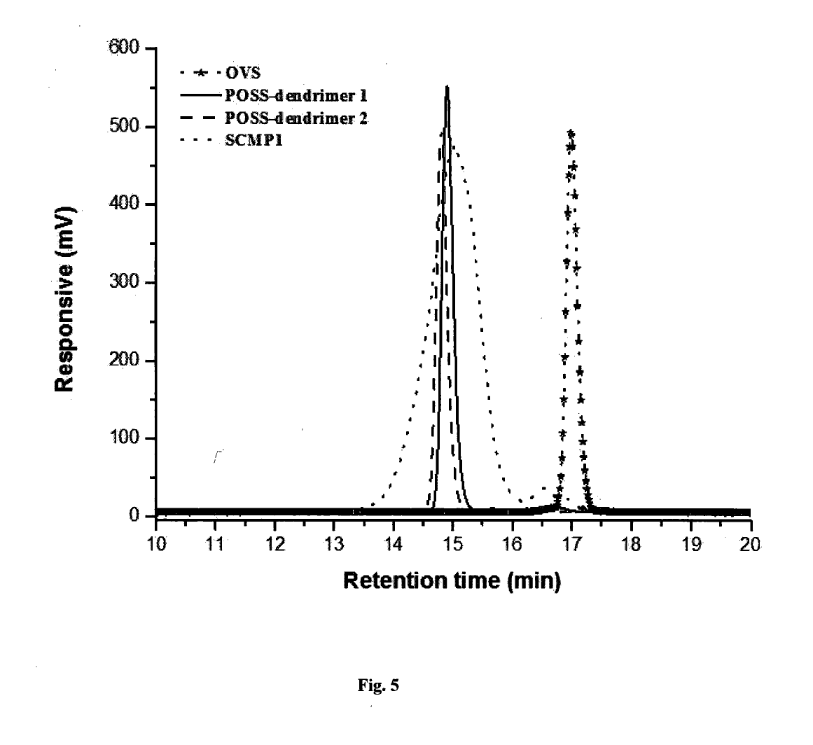

FIG. 5 shows GPC chromatograms of octavinylsilsesquioxane (OVS) [peak at 17 minutes], POSS-dend-1 (narrow peak at just under 15 minutes), POSS-dend-2 (narrow peak at just under 15 minutes) and SCMP1 (broader peak at just over 15 minutes).

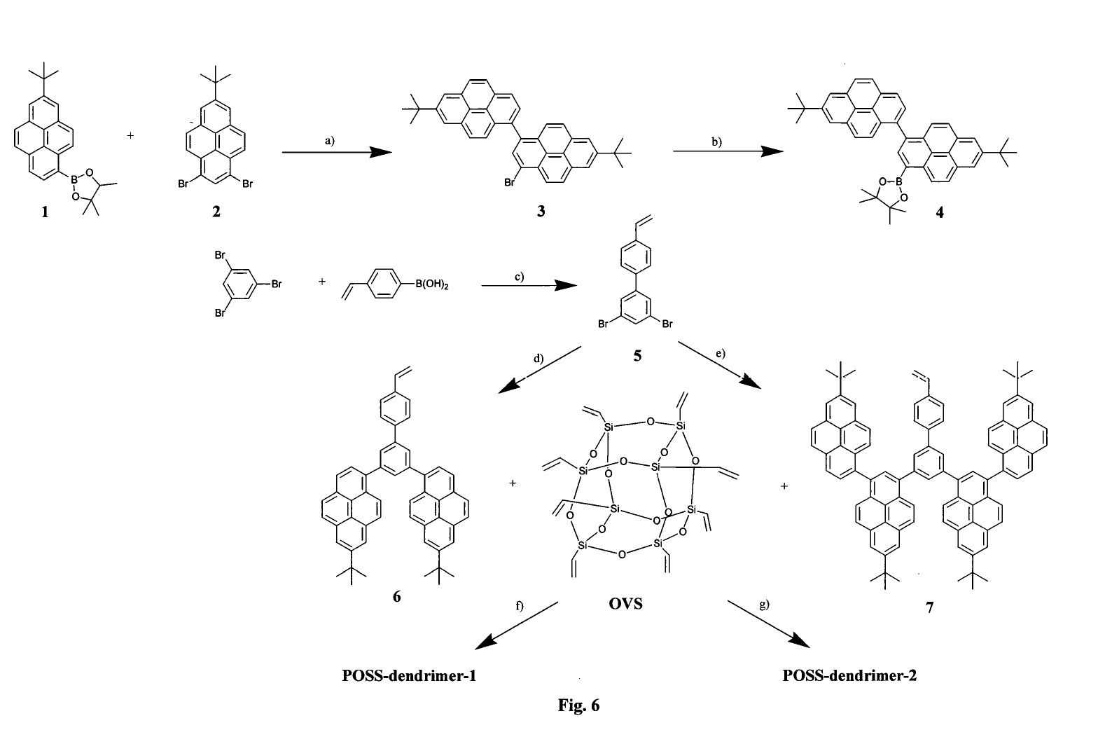

FIG. 6 shows a reaction scheme for the synthesis of POSS-dend-1 and POSS-dend-2. Reagents and conditions: a) Pd(PPh₃)₄, K₂CO₃, DMF, 110° C., 62%; b) bis(pinacolato)diboron, Pd(OAc)₂, KOAc, DMF, 80° C. 70%; c) Pd(PPh₃)₄, K₂CO₃, DMF/H₂O, 90° C., 76%; d) 1,^{[8]} Pd(PPh₃)₄, K₂CO₃, DMF, 90° C., 80%; e) 4, Pd(PPh₃)₄, K₂CO₃, DMF, 90° C., 55%; f) 6, Grabbs' catalyst, CH₂Cl₂, 55° C., 80%; h) 7, Grabbs' catalyst, CH₂Cl₂, 55° C., 56%.

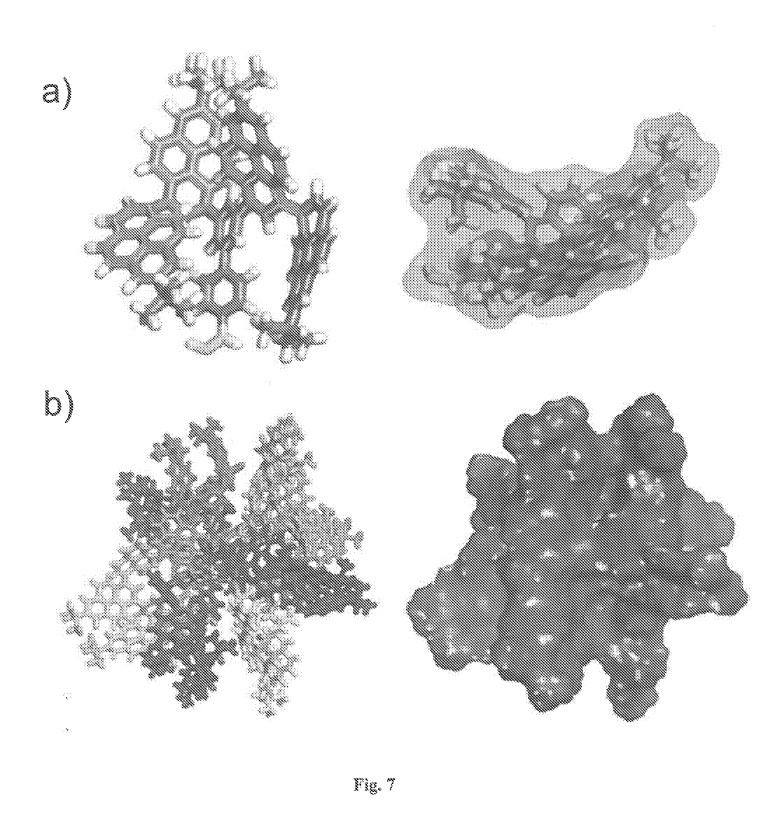

FIG. 7 shows an atomistic models of a dendron, the dendrimer, and solid-state packed dendrimer for POSS-dead-2. (a) Left: dendron with the linking ethene group highlighted; Right—side view, with a Connolly surface shown (probe radius of 1.82 Å) illustrating the concave shape of the dendron. (b) Left—dendrimer with each dendron highlighted in a different colour; Right—Connolly surface shown (probe radius of 1.82 Å) illustrating the irregular, stellated shape with cavities extending deep into the centre of the dendrimer.

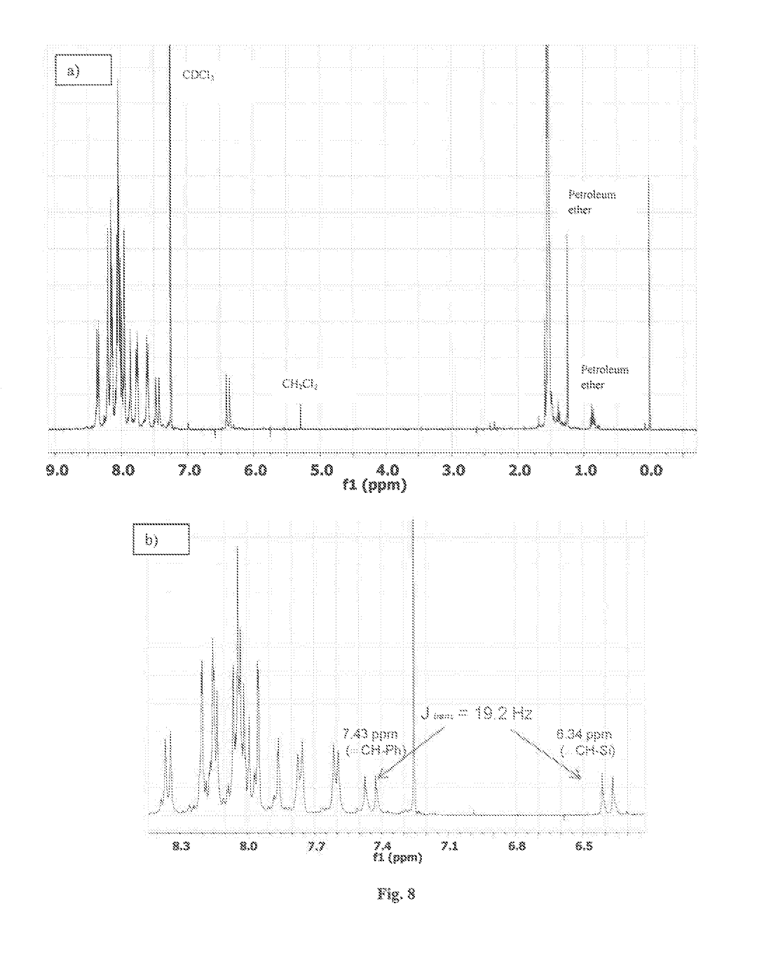

FIG. 8 shows: a) a ¹H NMR spectrum of POSS-dendrimer 1; b) an expanded spectrum from 6.2-8.4 ppm.

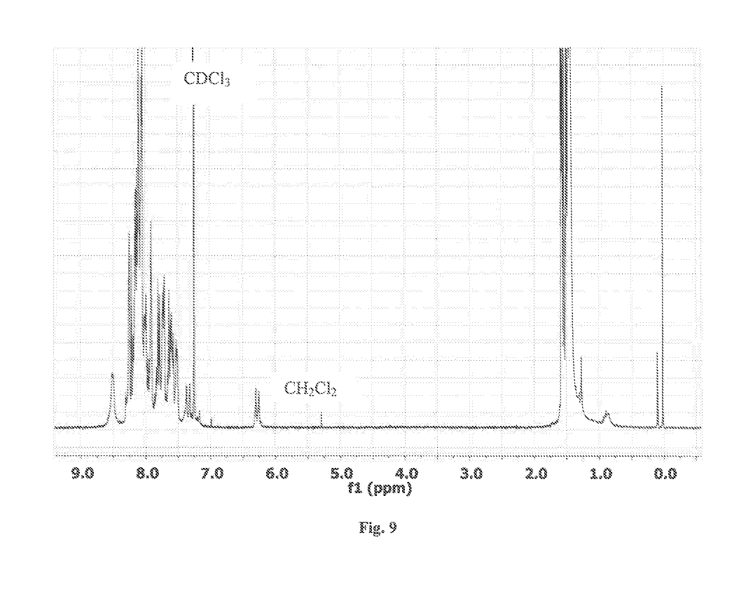

FIG. 9 shows a ¹H NMR spectrum of POSS-dendrimer 2.

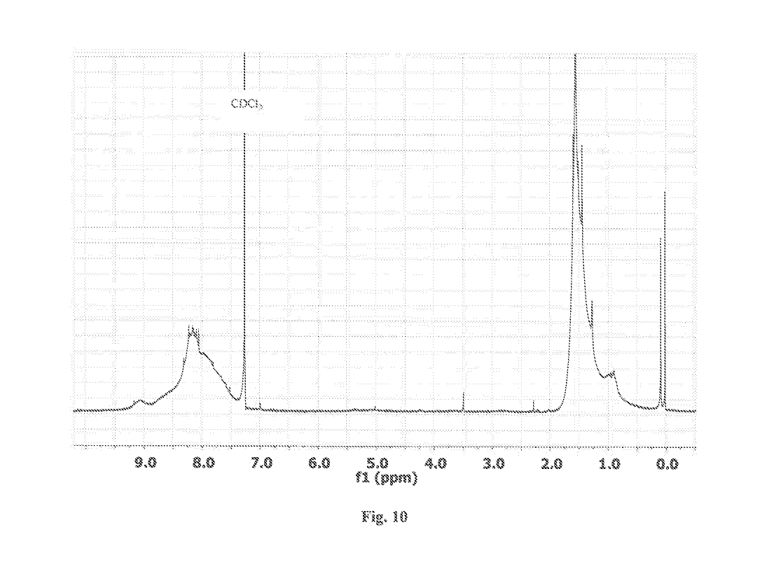

FIG. 10 shows a ¹H NMR spectrum of SCMP1.

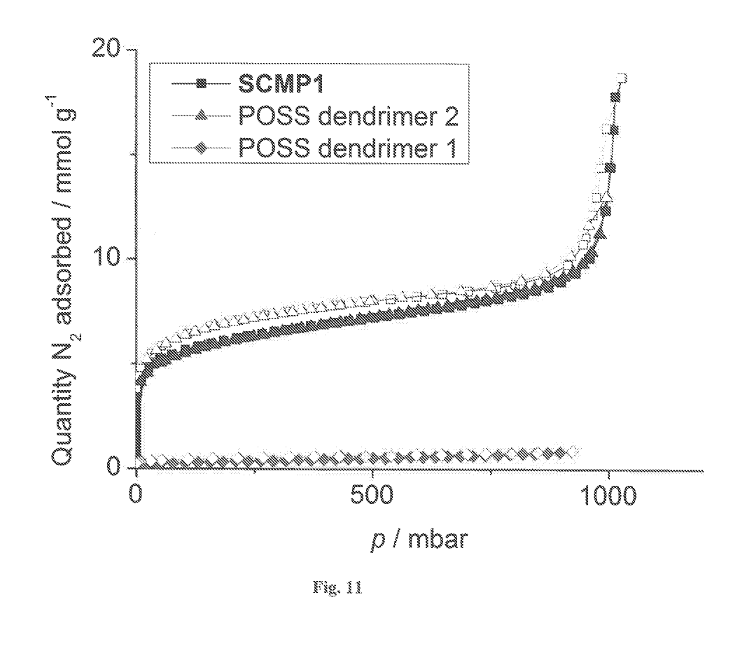

FIG. 11 shows nitrogen isotherms, at 77 K, for SCMP1 and POSS dendrimers 1 and 2, isolated from DCM by precipitation into petroleum ether. Adsorption curves are shown as closed symbols, desorption curves are shown as open symbols.

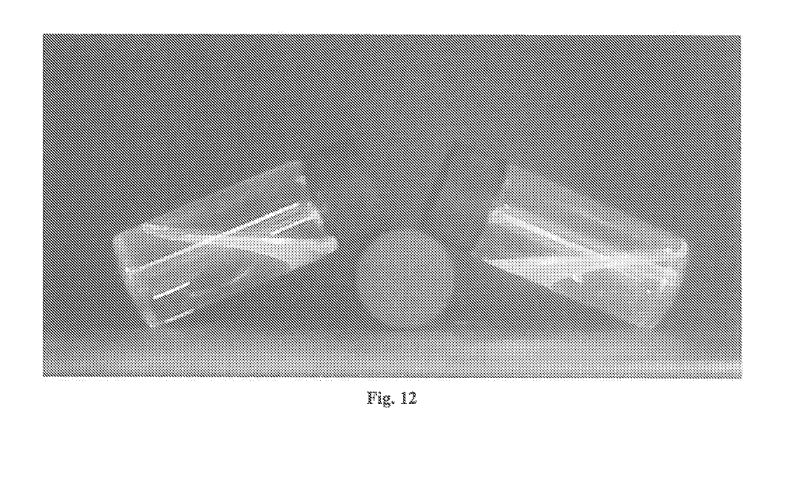

FIG. 12 is a photo showing POSS-dendrimers 1 and 2 solutions in THF (with blue luminescence under irradiation of UV light λ=254 nm).

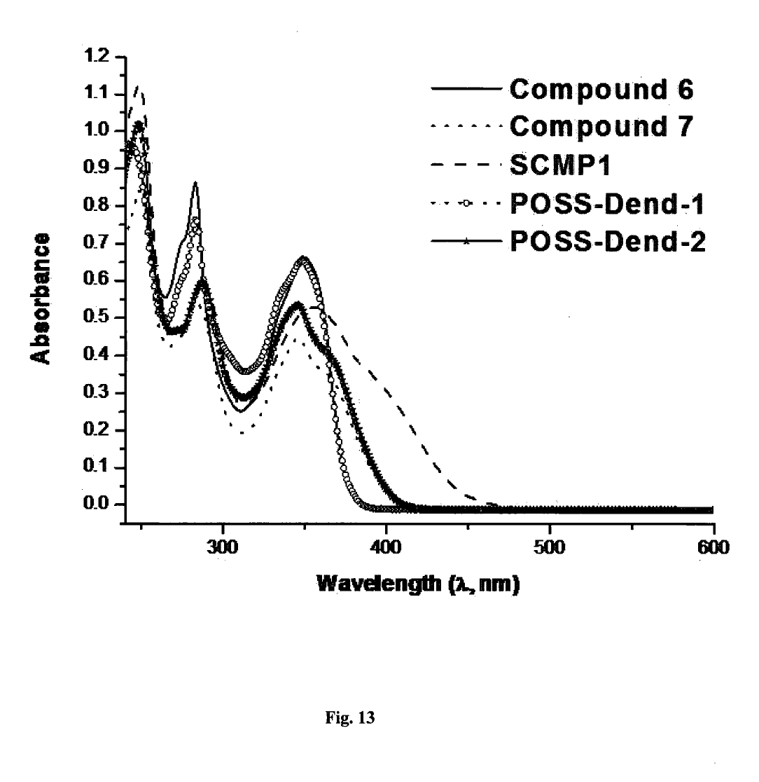

FIG. 13 shows absorption spectra of 6, 7, SCMP1, POSS-dend-1 and POSS-dend-2 in THF at room temperature (concentration of all solutions: 6.33×10⁻³ mg/ml).

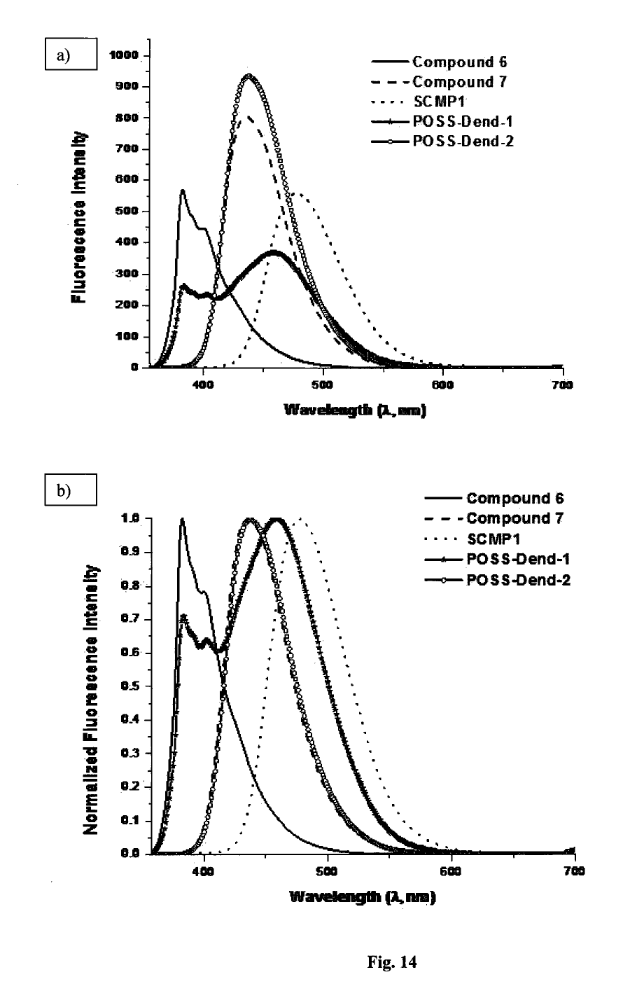

FIG. 14 shows: a) fluorescence spectra of 6, 7, SCMP1, POSS-dend-1 and POSS-dend-2 in THF at room temperature (concentration of all solutions: 9.04×10⁻³ mg/ml, excitation wavelength λₑₓ=350 nm); b) normalized fluorescence spectra.

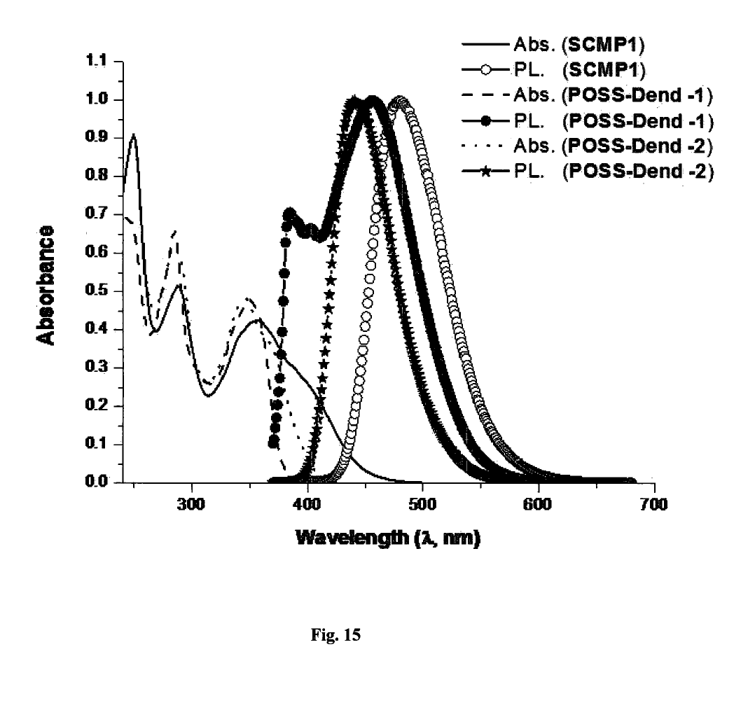

FIG. 15 shows: (Closed symbols:) Absorption spectra for SCMP1, and the dendrimers POSS-dend-1 and POSS-dend-2 in DCM at room temperature (concentration of all solutions: 6.33×10⁻³ mg-ml); (Open symbols:) normalized fluorescence spectra for same species.

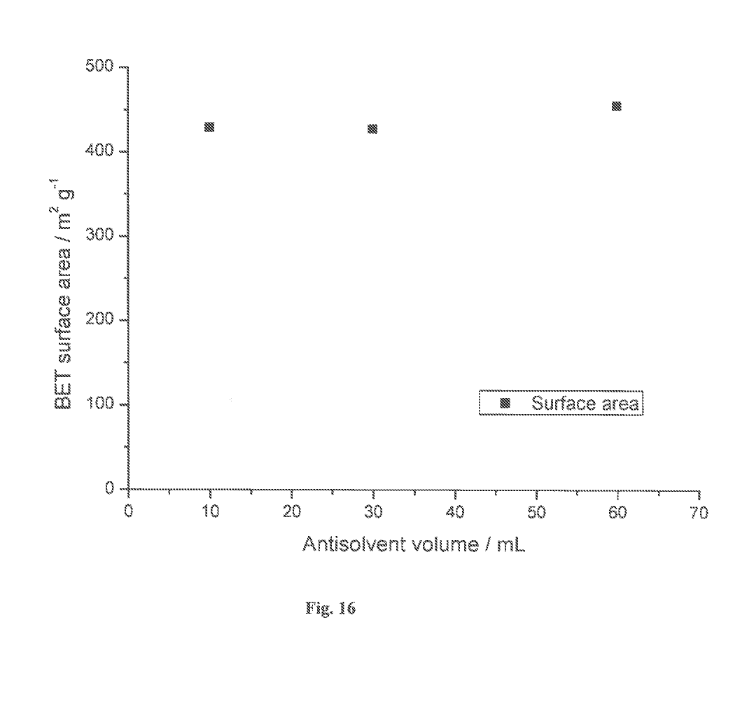

FIG. 16 shows the surface area of the SCMP1 material precipitated from DCM into methanol, plotted as a function of the volume of anti-solvent used.

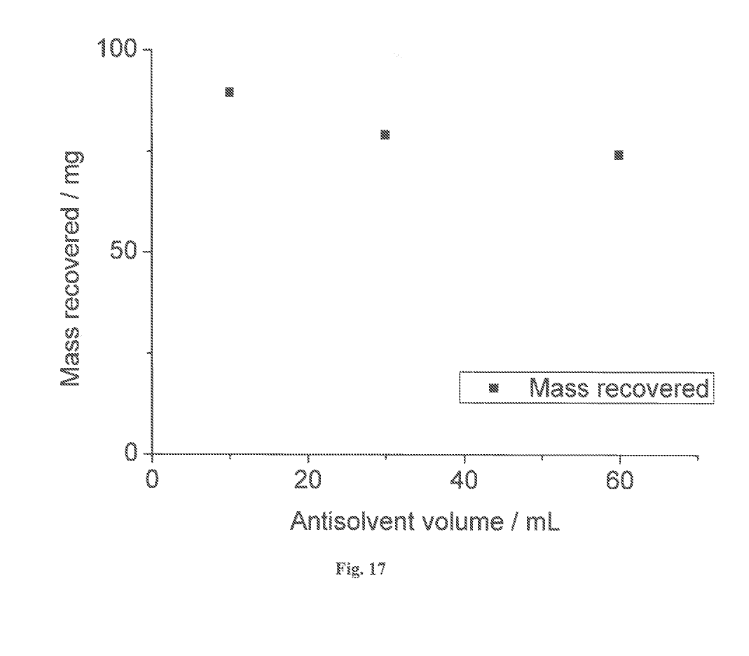

FIG. 17 shows the mass recovered of the SCMP1 material precipitated from DCM into methanol, as a function of the volume of anti-solvent used.

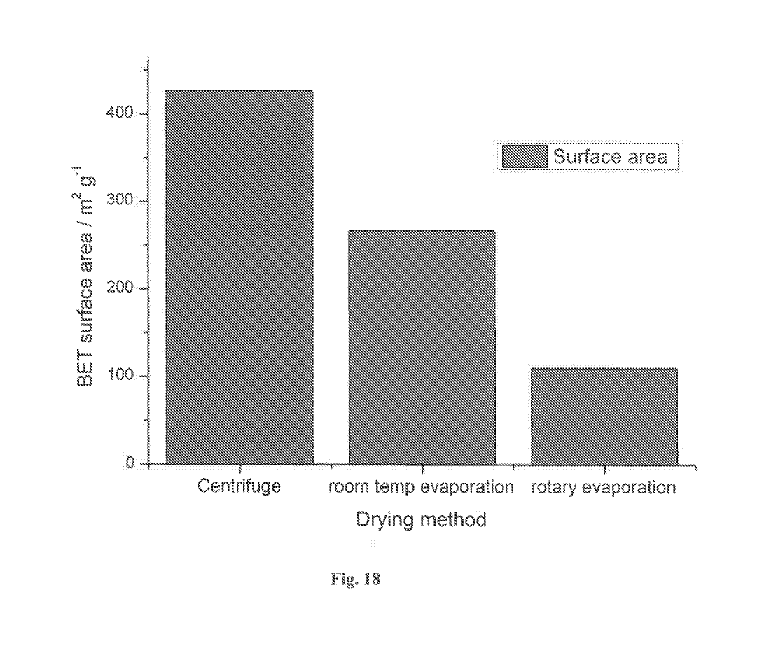

FIG. 18 shows the surface area of the precipitated SCMP1 material as a function of the drying method used.

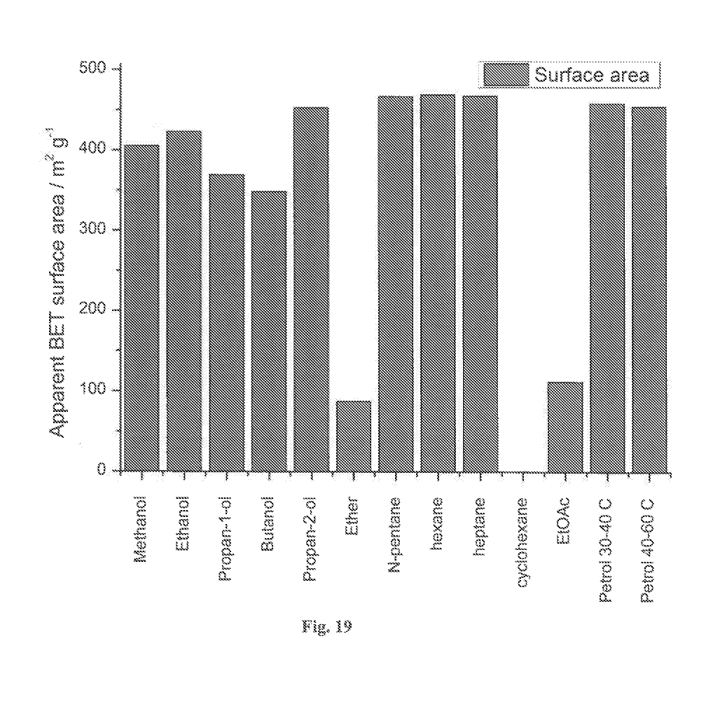

FIG. 19 shows the surface area of the precipitated SCMP1 material as a function of the anti-solvent used. Dioxane and toluene were also tested, but did not cause precipitation to occur (that, is, they are not antisolvents for SCMP1).

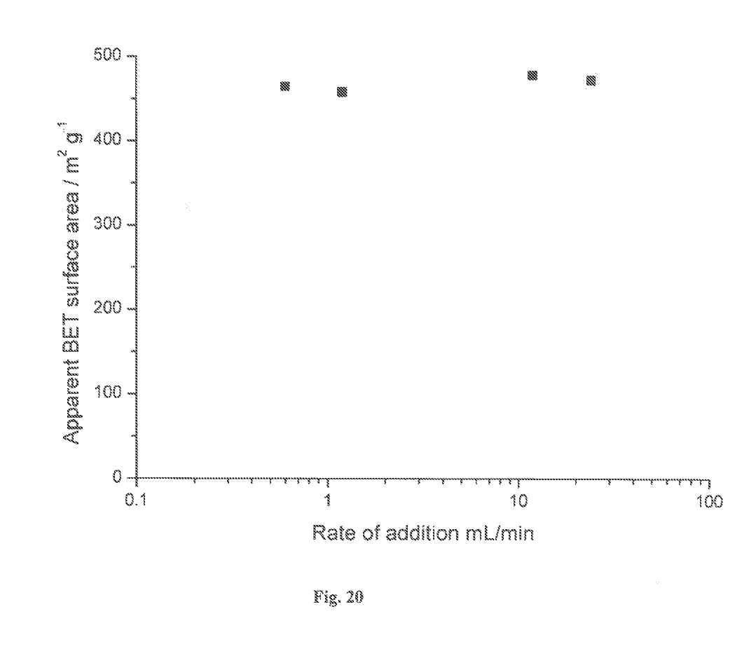

FIG. 20 shows the surface area of the precipitated SCMP1 material as a function of the rate of addition.

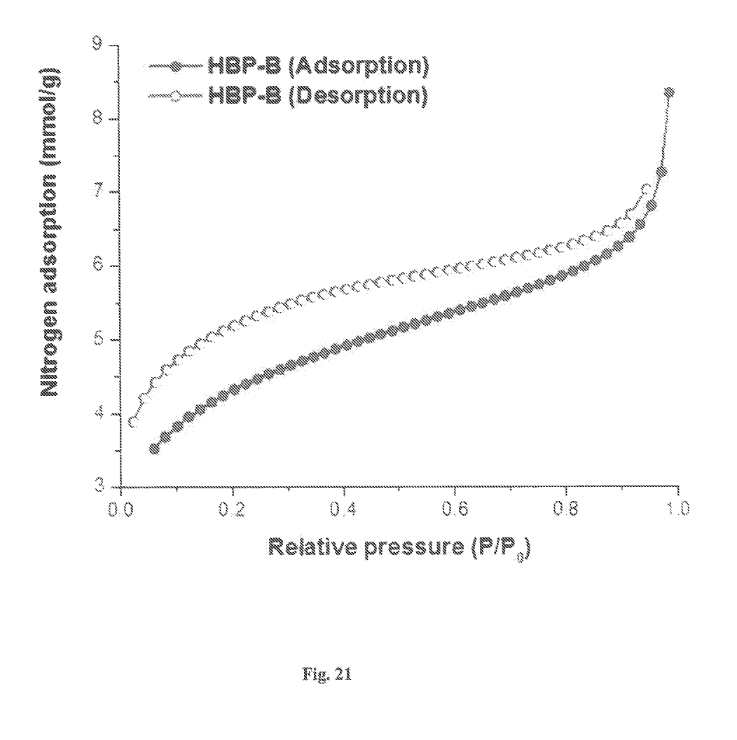

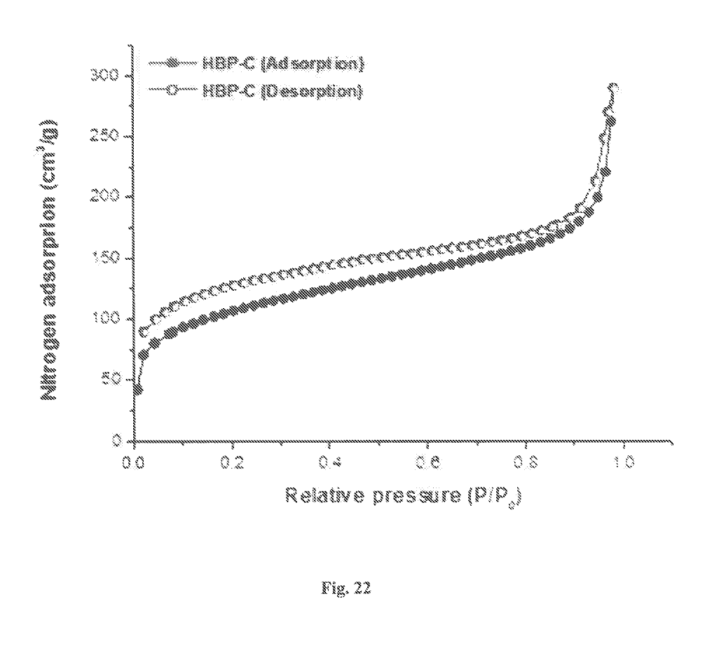

FIGS. 21 and 22 show nitrogen adsorption/desorption curves for two polymers, HBP-R and HBP-C.

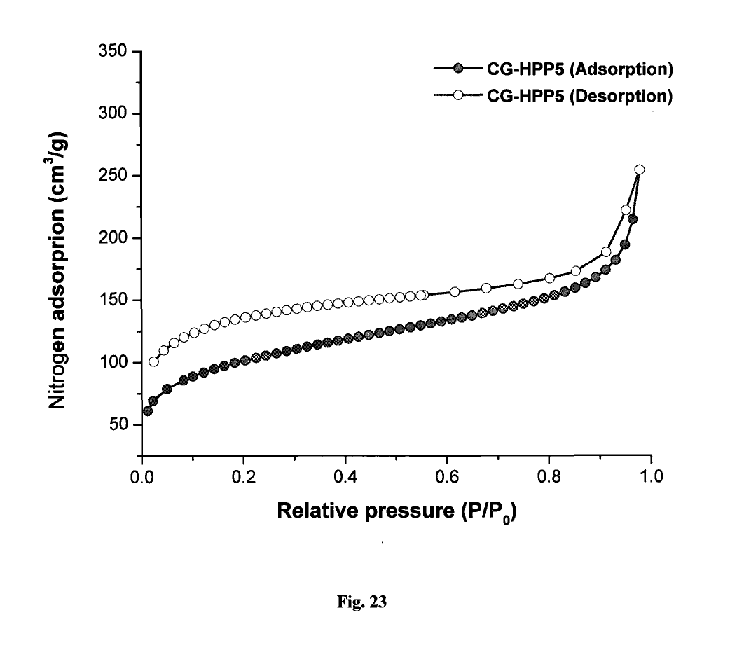

FIG. 23 shows nitrogen adsorption/desorption curves for CG-HPP5.

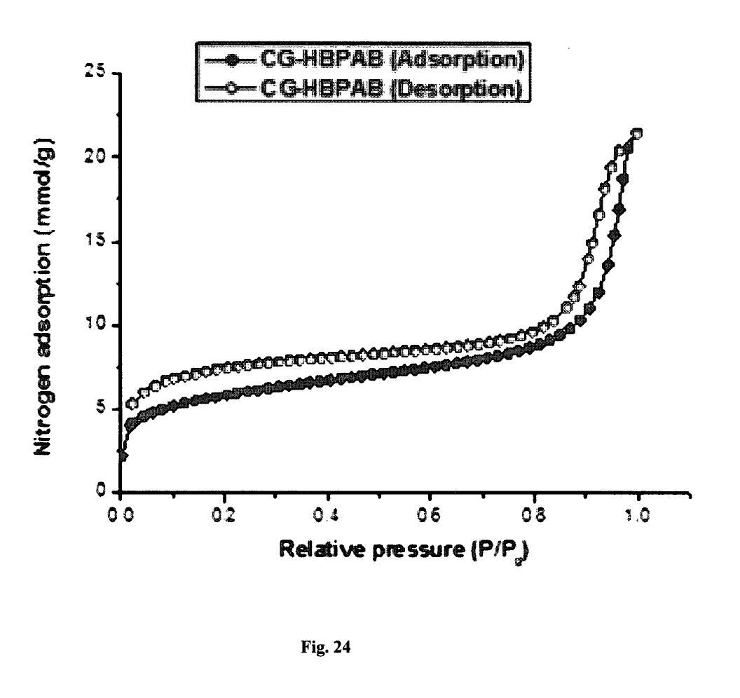

FIG. 24 shows nitrogen adsorption/desorption curves for CG-HPPAB.

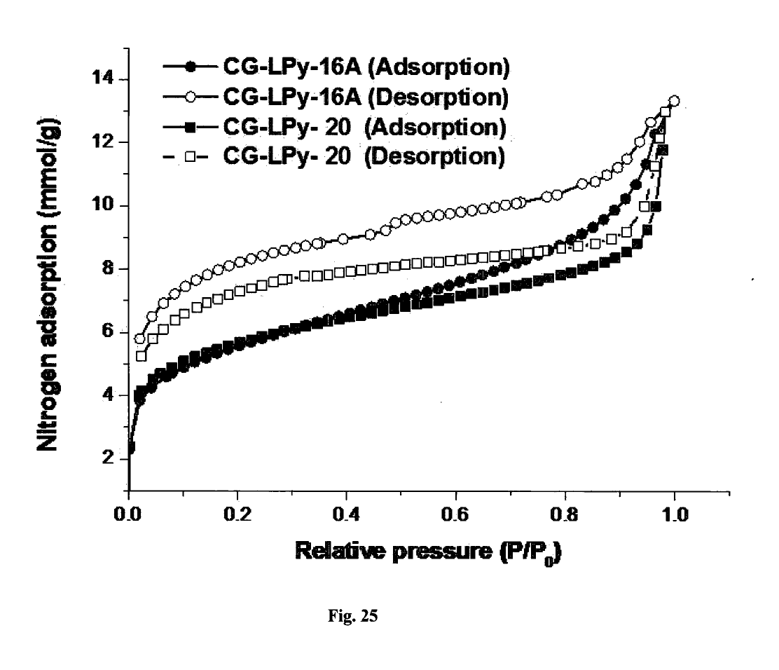

FIG. 25 shows nitrogen adsorption/desorption curves for CG-LPy-16a and CG-LPy-20.

Synthesis of the soluble conjugated microporous polymers in the following examples is based on hyperbranching, as used previously, for example, to prepare soluble hyperbranched polyphenylenes.^{[7]} In previous work, we focused on 1,3,6,8-tetrabromopyrene as an A₄ monomer, building on our studies of insoluble pyrene CMP networks.^{[8]} In the following examples, a tert-butyl-functionalized B₂ monomer is introduced to limit the molecular weight of the material and to incorporate solubilizing alkyl groups. To prepare the soluble CMPs, a two-step A₄+B₂ type Suzuki catalyzed aryl-aryl coupling copolymerization was performed (FIG. 1). In the first step, palladium acetate (Pd(OAc)₂)^{[9]} catalyzes an aryl halide/diboron coupling to generate arylboronates of both the A₄ monomer, 1,3,6,8-tetrabromopyrene, and the B₂ monomer, 1,3-dibromo-7-tert-butylprene,^{[10]} in a one-pot ‘prepolymerization’ reaction. Without isolating the arylboronate species, statistical copolymerization of the two monomers was then carried out in a second step by addition of Pd(PPh₃)₄ and K₂CO₃. After purification by antisolvent reprecipitation, the polymer was isolated as a deep yellow film. These materials dissolve in common organic solvents such as THF, CH₂Cl₂, and toluene to give homogeneous green luminescent solutions (FIG. 1).

SCMP1 is porous and the nature of the porosity depends on the method by which the material is isolated from solution. In particular, the porosity was different for materials precipitated rapidly in antisolvents in comparison with films prepared by slow solvent evaporation. A wide range of conditions and solvents were investigated but here we discuss two examples: antisolvent precipitation in a poor solvent (petroleum ether) and solution casting from a good solvent (dichloromethane, DCM). In both cases, SCMP1 was dissolved initially in DCM. For antisolvent precipitation, this DCM solution was added dropwise into excess petroleum ether. The rapidly precipitated SCMP1 powder was then removed by centrifugation (FIG. 2a). For solvent casting, the DCM was simply allowed to evaporate slowly on a glass slide, leaving the solid SCMP1 as a transparent, yellow film (FIG. 2b). Scanning electron microscope (SEM) images reveal the rapidly precipitated powder is comprised of fused spheres of around 100 nm in diameter (FIG. 2c), while the DCM-cast film has a smooth and uniform surface (FIG. 2d). The film is uniform and coherent but does not, in this first example, have sufficient mechanical strength to be self-supporting upon removal.

The nitrogen and hydrogen sorption isotherms for SCMP1 are shown, in FIGS. 2e and 2f. The rapidly precipitated SCMP1 shows a type II nitrogen isotherm and a clear micropore step at low relative pressures. The Brunauer-Emmett-Teller surface area (SA_{BET}) is 505 m² g⁻¹; that is, at the low end of the range for our first generation of insoluble CMP networks.^{[1a}] The upturn in the nitrogen isotherm at higher relative pressures indicates meso/macroporosity, presumably from the nanoscopic particles (FIG. 2c) and associated interparticle voids.

By contrast, the solvent-cast SCMP1 film is effectively non-porous to nitrogen at 77 K (BET surface=12 m² g⁻¹). Both materials, however, have a similar H₂ uptakes (˜4 mmol g⁻¹ at 1 bar, 77 K), although greater desorption hysteresis is observed for the solvent-east film. The difference in gas selectivity for the two samples may arise from the packing of the polymer molecules in the solid state, with the rapidly precipitated SCMP1 sample vitrifying into a less densely packed molecular structure. The solvent-evaporated SCMP1 sample forms a film that is selectively porous to hydrogen, suggesting potential in applications as coatings for gas separations. The solvent-cast SCMP1 film also adsorbs significant quantities of other gases such as CO₂, methane, and xenon at 273 K (FIG. 3).

The weight-averaged molecular weight of SCMP1, as measured by gel permeation chromatography (GPC) was 5,316 g mol⁻¹. However, accurate molecular weight determination for highly branched polymers is challenging using GPC, which uses linear polymers as calibration standards. To address this, two pyrene dendrimers^{[10]} were synthesised as control molecules with defined mass and structure. This also allowed comparison of the sorption properties of SCMP1 with those of analogous branched molecules with precisely controlled composition and mass. Two hybrid polyhedral oligomeric silsesquioxane (POSS)-polypyrene dendrimers were synthesized with peripheral dendrons that reflect the structure of the hyperbranched copolymer, SCMP1 (FIG. 4). These dendrimers were synthesized by a convergent cross-metathesis pathway using Grubb's catalyst^{[11]}.

POSS-dend-1 (FIG. 4a) has a calculated molecular weight, confirmed by mass spectrometry, of 5,952 g mol⁻¹. POSS-dend-2 has additional bulky groups in the dendrons (shown in pink FIG. 4b), and a higher mass of 10,053 g mol⁻¹. The dendrimers were dissolved in DCM and precipitated into petroleum ether in identical manner to the SCMP1 antisolvent process. POSS-dend-1 shows low nitrogen porosity in comparison to SCMP1, with an apparent BET surface area of 28 m²/g (FIG. 4c). POSS-dend-1 does adsorb H₂ at 77 K, but the isotherm shows hysteresis. POSS-dend-2, however, is much more porous with nitrogen sorption similar to SCMP1, with an apparent BET surface area of 498 m²/g and no hysteresis in the hydrogen isotherm (FIG. 4d). We suggest that POSS-dend-2 is less interpenetrated in the solid state than POSS-dend-1 as a result of the additional bulky pyrene groups (FIG. 4b), leading to a significant enhancement in microporosity. A structural model for POSS-dead-2 was constructed (FIG. 4e). A Connolly surface for the dendrimer (FIG. 4f) highlights its irregular shape and the existence of cavities extending deep within the dendrimer. It is likely that these cavities contribute to the permanent porosity of the rigid dendrimer in the solid state. An analogous type of microporosity can be envisaged in SCMP1, but the latter material is harder to simulate because it is not possible to define a single molecular building block.

The GPC elution curves for SCMP1 and the two pyrene dendrimers are shown in FIG. 5 and the data are summarized in Table 1.

TABLE 1
Molecular weight and sorption properties for SCMP1 and pyrene
dendrimers^{[a]}

| | M_{w} | Mₙ | | BET^{[b]} | N₂^{[c]}, H₂^{[d]} |
|---|---|---|---|---|---|
| Sample | (g mol⁻¹) | (g mol⁻¹) | PDI | (m² g⁻¹) | (mmol g⁻¹) |
| SCMP1 | 5,316 | 4,340 | 1.22 | 505 | 5.6, 3.8 |
| OVS | 560 | 551 | 1.01 | — | — |
| POSS-dend-1 | 4,709 | 4,651 | 1.01 | 28 | 0.3, 1.3 |
| POSS-dend-2 | 6,115 | 6,040 | 1.01 | 498 | 5.5, 3.5 |

^{[a]}Sorption data given for the antisolvent precipitated form;
^{[b]}Apparent BET surface area calculated over range P/P₀ = 0.01-0.1;
^{[c]}N₂ uptake at P/P₀ = 0.1, 77 K
^{[d]}H₂ uptake at 1 bar, 77 K.

The molecular weight distribution for SCMP1 is, unsurprisingly, broader than the dendrimers which are single molecule species. GPC underestimates the true molecular weights of the dendrimers. Overall, the GPC data suggest that the molecular weight for SCMP1 falls in the same range as the two dendrimers. The porous properties of antisolvent-precipitated POSS-dend-2 and SCMP1 are also very similar, and their N₂ sorption isotherms overlay almost exactly.

Both POSS-dend-1 and POSS-dend-2 display strong blue luminescence when their solutions are irradiated by UV light.^{[12]} Solutions of SCMP1 are also photoluminescent due to the conjugated structure of the polymer (FIG. 1). Absorption and emission spectra are shown in FIGS. 13 to 15. It was shown for pyrene-based dendrimers and polymers, that an increase in extended conjugation causes a red shift in fluorescence.^{[8,10]}

Here, fluorescence in SCMP1 is more red-shifted because the POSS core breaks the conjugation in the dendrimers. The larger red shift in fluorescence for POSS-dend-1 with respect to POSS-dend-2 is not at present understood, but could stem from reduction in conjugation arising from steric constraints in the larger dendrimer.

Thus, we have demonstrated for the first time that soluble conjugated microporous polymer, SCMPs, can be prepared by adapting the synthesis conditions to form discrete hyperbranched chains rather than extended networks. These materials can be processed from solution to form films, and the resultant porosity is a function of the processing conditions. Soluble conjugated dendrimers can also exhibit microporosity, and we suggest that the structural origin of microporosity—rigidity combined with non-interpenetrating cavities—is probably similar in both cases. From a practical viewpoint, however, SCMPs are preferable to dendrimers because they can be prepared in a simple two-step, one-pot procedure.

Experimental Section

Synthesis of SCMP1:

Step 1 (pre-polymerization): To an oven-dried 500 ml round-bottom flask equipped with a reflux condenser were charged 1,3,6,8-tetrabromopyrene (A₄) (2.58 g, 5.0 mmol), 1,3-dibromo-7-tert-butylprene^{[10]} (B₂) (4.16 g, 10.0 mmol), bis(pinacolato)diboron (C) (8.00 g, 31.5 mmol), palladium acetate, Pd(OAc)₂ (240 mg, 1.07 mmol), potassium acetate, KOAc (5.80 g, 59.10 mmol), and anhydrous dimethylformamide, DMF (275 mL) under a nitrogen atmosphere. After the mixture was degassed, it was heated and stirred at 90° C. for 22 h.

Step 2 (polymerization): The pre-polymerized mixture was cooled down to room temperature and Pd(PPh₃)₄ (680 mg, 0.59 mmol), K₂CO₃ (4.80 g, 34.73 mmol), and H₂O (25 mL) were added and the solution degassed. The mixture was then heated to 120° C. and stirred for 5 days under a nitrogen atmosphere.

Purification of SCMP1:

Step 1: The resulting deep green mixture was diluted with DCM (500 mL), washed with 20% HCl solution followed by brine until the green organic layer changed to brown; it was then washed with water and dried over MgSO₄. The clear solution was concentrated at reduced pressure and any Pd-black particles were removed by passing through a short silica gel column, followed by elution with THF. The organic solution was then concentrated and precipitated twice from DCM (40 mL) into MeOH (320 mL). The polymer product was isolated by centrifugation and dried in vacuum at 120° C. to give 3.2 g of a light-yellow powder.

Step 2: This light-yellow powder was dissolved in DCM (20 mL) and absorbed on 10 g silica gel and air dried followed by Soxhlet extraction with hot hexane, a poor solvent for the SCMP, for 3 days. The hexane solution was replaced with THF, a good solvent for the SCMP, to extract the polymer from the silica gel over 2 days. The THF was removed by rotary evaporation to give 2.6 g of the product, SCMP1, as a deep yellow film (yield=81% by weight). GPC analysis: M_{w}=5,316 g/mol, Mₙ=4,340 g/mol, PDI=1.22. ¹H NMR (400 MHz, CDCl₃)δ: 9.1-7.3 (br, -pyrenyl and 1.9-0.3 (br, —CH₃). Assuming no end groups, a ratio of aromatic: tert-butyl groups of 1.11:1 would be expected. For SCMP1, an integration of 0.625:1 is found. After hydrolysis of boronic ester end groups using BBr₃, a ratio of 1.08:1 was measured, very close to the theoretical value. Hence, the feed ratio is maintained, but the polymer also contains a significant number of end groups, as expected from the relatively low molecular weight.

Typical antisolvent reprecipitation conditions: SCMP1 was dissolved in CH₂Cl₂ (1 mL) at 80 mg/mL concentration and added dropwise to petroleum ether (10 mL, b.p. 40-60° C.). The resulting precipitated material was separated by centrifugation for 5 minutes at 5,000 r.p.m. before decanting the supernatant.

Film casting: SCMP1 was dissolved in CH₂Cl₂ (1 mL) at 80 mg/mL concentration. The CH₂Cl₂ was subsequently allowed to evaporate under nitrogen flow, leaving the polymer as a coherent film on the glass surface of the containment vessel.

Dendrimers: The synthesis and purification of POSS-Dend-1 and POSS-dend-2 are detailed below.

Synthesis and Characterisation

Materials: All reagents and solvents were purchased from Aldrich except for bis(pinacolato)diboron, which was purchased from TCI UK Fine Chemicals. All reactions were carried out under a nitrogen atmosphere. Thin layer chromatography (TLC) was performed using pre-coated aluminum sheets with silica gel 60 F₂₅₄ (Merck) and visualized by UV light (λ=254 or 280 nm). Merck silica gel 60 was used for column chromatograph. Solution ¹H NMR spectra were collected on a Bruker UXNMR/XWIN-NMR 400 MHz spectrometer. Gel permeation chromatography (GPC) utilize a LC 1120 HPLC pump, a PL-ELS 1000 Evaporative Light Scattering Detector, a PL gel 5 μm MIXED-C GPC column and Midas autosampler (Polymer Laboratories Ltd. UK). THF was used as the eluent with flow rate of 1.00 mL/min at 40° C. and polystyrene as the standard. The absorption spectra were recorded on UV-2550 UV-Vis spectrophotometer. The fluorescence spectra were run on RF-5301PC SHIMADZU spectrofluorophotometer. Compound 1 (7-tert-butylpyrene-1-boronic pinacol ester) and 2 (1,3-dibromo-7-tert-butylpyrene) were synthesized according to a literature procedure.^{[8]}

Synthesis of Compound 3

To an oven-dried 250-mL flask equipped with a condenser and a magnetic stirring bar were charged compound 1 (3.40 g, 8.85 mmol), 2 (4.77 g, 11.44 mmol), Pd(PPh₃)₄ (435 mg, 0.38 mmol), K₂CO₃ (1.91 g, 13.82 mmol), and DMF (100 mL).

After the resulting mixture was degassed, it was stirred at 110° C. for 24 h. After cooling, the mixture was diluted with CH₂Cl₂, washed with 20% HCl solution, brine, water, and dried over MgSO₄. The organic layer was filtered and evaporated to dryness, followed by column chromatography on silica gel using a gradient from petroleum ether (40-60° C.) to dichloromethane/ petroleum ether (40-60° C.) (1:9) to afford a yellow powder 3 (3.27 g) in 62% yield. ¹H-NMR (400 MHz, CDCl₃):δ8.53 (d, J=9.2 Hz, 1H), 8.39 (s, 1H), 8.30 (d, J=10.4 Hz, 3H), 8.24 (d, J=9.6 Hz, 1H), 8.19 (d, J=6 Hz, 2H), 8.16 (s, 2H), 8.07 (d, J=8 Hz, 1H), 7.85(AB, J=6.4 Hz, 2H), 7.56(AB, J=9.2 Hz, 2H), 1.58 (s, 18H). ¹³C-NMR (100 MHz, CDCl₃): 150.40, 149.80, 137.50, 135.04, 132.58, 131.74, 131.64, 131.42, 131.40, 131.20, 130.20, 129.92, 129.72, 129.62, 128.70, 128.43, 128.39, 127.70, 126.36, 126.02, 125.83, 125.09, 124.79, 123.53, 123.47, 123.38, 123.09, 122.89, 119.79, 35.67, 32.33, 32.28. EI-MS: calcd. for C₄₀H₃₃Br 594.2; found 594.5 [M]⁺. Anal. calc. C₄₀H₃₃Br for: C 80.94, H 5.60; found: C 80.67, H 5.70.

Synthesis of Compound 4

To an oven-dried 250-mL flask equipped with a condenser and a magnetic stirring bar were charged compound 3 (2.97 g, 5.00 mmol), bis(pinacolato)diboron (2.05 g, 8.06 mmol), palladium acetate Pd(OAc)₂ (142 mg, 0.63 mmol), potassium acetate KOAc (1.62 g, 16.44 mmo), and anhydrous DMF (100 mL). After the mixture was degassed, it was heated and stirred at 90° C. overnight. After cooling, the mixture was diluted with CH₂Cl₂, washed with 20% HCl solution, brine, water and dried over MgSO₄. The organic layer was filtered and evaporated to dryness, followed by column chromatography on silica gel using a gradient from dichloromethane/petroleum ether (40-60° C.) 1:9 to 2:8 to afford a yellow powder 4 (2.24 g) in 70% yield. ¹H-NMR. (400 MHz, CDCl₃):δ 9.13 (d, J=9.2 Hz, 1H), 8.63 (s, 1H), 8.30 (d, J=7.6 Hz, 1H), 8.29 (d, J=1.6 Hz, 1H), 8.27 (d, J=1.6 Hz, 1H), 8.21-8.12 (m, 6H), 7.84 (dd, J=9.2 Hz, 2H), 7.58 (t, J=9.6 Hz, 2H), 1.58 (d, J=2.8 Hz, 18H), 1.47 (d, J=3.6 Hz, 12H). ¹³C-NMR (100 MHz, CDCl₃): 149.57, 149.43, 137.03, 136.83, 136.56, 136.43, 136.34, 132.52, 131.76, 131.41, 131.20, 131.09, 130.32, 129.22, 128,98, 128.51, 128.40, 128.04, 127.96, 127.78, 126.40, 126.21, 125.01, 124.75, 123.40, 123.23, 122.99, 122.78, 122.64, 84.35, 35.632, 32.33, 25.47. EI-MS: calcd. for C₄₆H₄₅BO₂ 640.3; found 640.7 [M]⁺. Anal. calc. C₄₆H₄₅BO₂ for: C 86.24, H 7.08; found: C 85.89, H 7.18.

Synthesis of Compound 5

To an oven-dried 50-mL flask equipped with a condenser and a magnetic stirring bar were charged 4-styrene boronic acid (754.65 mg, 5.00 mmol), 1,3,5-tribromobenzene (2.8 g, 8.85 mmol, Pd(PPh₃)₄ (290 mg, 0.25 mmol), K₂CO₃ (1.91 g, 10.05 mmol), DMF (30 mL), and water (15 mL). After the resulting mixture was degassed, it was stirred at 90° C. for 40 h. After cooling, the mixture was diluted with CH₂Cl₂, washed with 20% HCl solution, brine, water, and dried over MgSO₄. The organic layer was filtered and evaporated to dryness, followed by column chromatography on silica gel with petroleum ether (40-60° C.) as eluent to afford a white powder 5 (1.3 g) in 76% yield. ¹H NMR (400 MHz, CDCl₃, ppm) δ: 7.65 (d, J=1.6 Hz, 2H), 7.62 (t, J=2 Hz, 1H), 7.49 (s, 4H), 6.75 (dd, J=10.8 Hz, 17.6 Hz, 1H), 5.81(d, J=17.6 Hz, 1H), 5.30 (d, J=10.8 Hz, 1H). ¹³C-NMR (100 MHz, CDCl₃): 144.69, 138.19, 137.95, 136.45, 132.98, 129.16, 127.61, 127.26, 123.70, 115.21. EI-MS: calcd. for C₁₄H₁₀Br₂ 337.9; found 338.2 [M]⁺. Anal. calc. C₁₄H₁₀Br₂ for: C 49.74, H 2.98; found: C 49.10, H 2.82.

Synthesis of Compound 6

To an oven-dried 50-mL flask equipped with a condenser and a magnetic stirring bar were charged compound 1 (1.4 g, 3.63 mmol), 5 (507 mg, 1.50 mmol), Pd(PPh₃)₄ (190 mg, 0.16 mmol), K₂CO₃ (866 mg, 6.26 mmol) and DMF (30 mL). After the resulting mixture was degassed, it was stirred at 90° C. for 48 h. After cooling, the mixture was diluted with CH₂Cl₂, washed with 20% HCl solution, brine, water and dried over MgSO₄. The organic layer was filtered and evaporated to dryness, followed by column chromatography on silica gel with dichloromethane/petroleum ether (40-60° C.) (1:9) as eluent to afford a yellow powder 6 (0.83 g) in 80% yield. ¹H NMR (400 MHz, CDCl₃, ppm) δ: 8.43 (d, J=9. 2Hz, 2H), 8.24 (d, J=2 Hz, 3H), 8.22 (t, J=2 Hz, 3H), 8.13 (d, J=8 Hz, 2H), 8.07 (d, J=8.8 Hz, 6H), 8.01 (d, J=8 Hz, 2H), 7.92 (t, J=1.6 Hz, 1H), 7.77 (d, J=8.4 Hz, 2H), 7.53 (d, J=8.4 Hz, 2H), 6.77 (dd, J=10.8 Hz, 17.6 Hz, 1H), 5.81 (d, J=17.6 Hz, 1H), 5.29(d, J=10.8 Hz, 1H), 1.59 (s, 18H). ¹³C-NMR. (100 MHz, CDCl₃): 149.22, 142.01, 140.85, 140.23, 137.15, 136.96, 136.36, 131.77, 131.34, 130.85, 130.63, 128.44,128.09, 128.00, 127,78, 127.52, 127.43, 127.29, 126.84, 125.12, 125.01, 124.58, 123.18, 122,54, 122.24, 114.17, 35.26, 31.96. MALDI-MS: calcd. for C₅₄H₄₄ 692.3; found 692.1 [M]⁺. Anal. calc. for C₅₄H₄₄: C 93.60, H 6.40; found: C 92.88, H 6.52.

Synthesis of Compound 7

To an oven-dried 50-mL flask equipped with a condenser and a magnetic stirring bar were charged compound 4 (1.36 g, 2.10 mmol), 5 (272 mg, 0.81 mmol), Pd(PPh₃)₄ (118 mg, 0.10 mmol), K₂CO₃ (527 mg, 3.81 mmol) and DMF (20 mL). After the resulting mixture was degassed, It was stirred at 90° C. for 48 h. After cooling, the mixture was diluted with CH₂Cl₂, washed with 20% HCl solution, brine, water and dried over MgSO₄. The organic layer was filtered and evaporated to dryness, followed by column chromatography on silica gel with dichloromethane/petroleum ether (40-60° C.) (1:9) as eluent to afford a yellow powder 7 (0.53 g) in 55% yield, ¹H-NMR (400 MHz, CDCl₃):δ 8.56 (d, J=8.8 Hz, 2H), 8.30 (s, 2H), 8.28-8.23 (m, 6H), 8.19-8.09 (m, 15H), 7.84 (d, J=8.8 Hz, 2H), 7.81 (d, J=8.4 Hz, 2H), 7.76 (d, J=8.4 Hz, 2H), 7.69 (d, J=9.2 Hz, 2H), 7.62 (dd, J=1.2 Hz, 9.2 Hz, 2H), 7.47 (d, J=8.4 Hz, 2H), 6.73 (dd, J=10.8 Hz, 17.6 Hz, 1H), 5.76(d, J=17.6 Hz, 1H), 5.25 (d, J=10.8 Hz, 1H), 1.57 (s, 18H), 1.56 (s, 9H), 1.55 (s, 9H). ¹³C-NMR (100 MHz, CDCl₃): 149.81, 149.62, 142,32, 140.59, 137.32, 137,12, 136.77, 136.46, 136.36, 132.37, 131.73, 131.62, 131.58, 131,23, 131.17, 130.59, 130,26, 129.95, 128.97, 128,76, 128.61, 128.53,128,21, 128.15, 127.95, 127.75,127.19, 126.24, 126,20, 125.61, 125,08, 124.82, 123.74, 123.43, 122,99, 122.89, 122.73, 114.49, 35.65, 32.33. MALDI-MS: calcd. for C₉₄H₇₆ 1204.6; found 1204. 6[M]⁺. Anal. calc. for C₅₄H₄₄: C 93.65, H 6.35: found: C 93.08, H 6.15.

Synthesis of POSS-dend-1

To an oven-dried flask equipped with a condenser and a magnetic stirring bar were charged octavinylsilsesquioxane (OVS) (35.80 mg, 0.057 mmol) and 6 (520 mg, 0.75 mmol) in anhydrous CH₂Cl₂ (8 mL). After the solution was degassed by “freeze-pump-thaw” cycles and it was stirred and heated to maintain a gentle reflux at 55° C. A solution of Grabbs' catalyst (40 mg, 0.048 mmol in 3 ml CH₂Cl₂) was injected with syringe. The reaction mixture was refluxed and monitored by ¹H NMR spectroscopy. The proton resonances of vinylsilyl groups disappeared after 90 hours and the reaction was cooled to room temperature. The reaction mixture was diluted with CH₂Cl₂, washed with 20% HCl solution, brine, water, and dried over MgSO₄. The solution was concentrated, followed by column chromatography on silica gel using a gradient from petroleum ether (40-60° C.) to diehloromethane/petroleum ether (40-60° C.) (1:9) to afford an off-white powder, which, was repeatedly precipitated from THF/MeOH to give POSS-dend-1 as white powder (270 mg, 80%). GPC analysis: Mₙ=4709 g/mol M_{W}=4651 g/mol and PDI−1.01. ¹H NMR (400 MHz, CDCl₃, ppm) δ: 8,35 (d, J=9.2 Hz, 16H), 8.21-8.12 (m, 48H), 8.06-7.93 (m, 80H), 7.85 (brs, 8H), 7.76 (d, J=8.4 Hz, 16H), 7.60 (d, J=8.4 Hz, 16H), 7.43 (d, J=19.2 Hz, 8H), 6.39 (d, J=19.2 Hz, 8H), 1.53 (s, 144H). ¹³C-NMR (100 MHz, CDCl₃): 149.53, 149.05, 142.32, 141.67, 141.13., 137.44, 137.15, 131.70, 137.19, 130.96, 128.77, 128.45, 128.34, 128.11, 127.98, 127.96, 127.76, 127.65, 125.44, 125.34, 124.92, 123.54, 122.85, 122.59, 118,13, 117.74, 35.59, 32.30. MALDI-MS: calcd. for C₄₃₂H₃₄₄O₁₂Si₈ 5951.46; found 5951.41[M]⁺. Anal. calc. for C₅₄H₄₄: C 93.65, H 6.35; found: C 93.08, H 6.15. Anal. calc. for C₄₃₂H₃₄₄O₁₂Si₈: C 87.17, H 5.83; found: C 86.42, H 5.74.

Synthesis of POSS-dend-2

To an oven-dried flask equipped with a condenser and a magnetic stirring bar were charged octavinylsilsesquioxane (GVS) (22.00 mg, 0.035 mmol) and 7 (530 mg, 0.44 mmol) in anhydrous CH₂Cl₂ (18 mL). After the solution was degassed by “freeze-pump-thaw” cycles and it was stirred and heated to maintain a gentle reflux at 55° C. A solution of Grubbs' catalyst (40 mg, 0.048 mmol in 3 mL CH₂Cl₂) was injected with syringe. The reaction mixture was refluxed and monitored by ¹H NMR spectroscopy. The proton resonances of vinylsilyl groups disappeared after 90 hours and the reaction was cooled to room temperature. The reaction mixture was diluted with CH₂Cl₂, washed with 20% HCl solution, brine, water and dried over MgSO₄. The solution was concentrated, followed by column chromatography on silica gel using a gradient from dichloromethane/petroleum ether (40-60° C.) 1:9 to 3:7 to afford an off-white powder, which was repeatedly precipitated from THF/MeOH to give POSS-dend-2 as white powder (197 mg, 56%). GPC analysis: Mₙ=6115 g/mol, M_{W}=6040 g/mol and PD=1.01. ¹H NMR (400 MHz, CDCl₃, ppm) δ: 8.50 (brs, 16H), 8.31-7.88 (m, 184H), 7.86-7.49 (m, 96H), 1.58-1.37 (s, 288H). ¹³C-NMR (100 MHz, CDCl₃): 149.48, 148.89, 137.34, 137.01, 136.68, 136.65, 136.42, 136.27, 132.04, 131.62, 131.56, 131.13, 131.05, 130.58, 130.17, 129.90, 128.92, 128.89, 128.78, 128.54, 128.23, 128.15, 127.98, 127.90, 127.66, 1.26.17, 125.58, 124.99, 124.75, 123.71, 123.34, 122.90, 122.84, 122.63, 35.50, 32.23. MALDI-MS: calcd. for C₇₅₂H₆₀₀O₁₂Si₈ 10049.47; found 10049.41[M]⁺. Anal. calc. C₇₅₂H₆₀₀O₁₂Si₈ for: C 89.84, H 6.02; found: C 88.75, H 6.15.

Atomistic Simulations

A structural model of the POSS-dend-2 dendron was constructed using Materials Studio 5.0 (Accelrys Inc.) and geometry optimised using the Forcite module and COMPASS force field (force field charge assignment). The resulting dendron structure is buckled and contorted with a concave bowl-like shape, as shown in FIG. 7a. This dendron was used to construct a dendrimer by attaching eight of the dendrons to the silicon atoms of the POSS core through the terminal ethene group. Subsequently, the molecule was fully geometry optimised using the Forcite module and COMPASS force field. The resulting dendrimer exhibits a stellated cube topology with the eight dendrons extending outwards from the cuboid POSS core, as shown in FIG. 7b. A Connolly surface (probe radius 1.82 Å—the kinetic radius of N₂) was calculated for the dendrimer and is also shown in FIG. 7b. The Connolly surface is highly irregular with cavities extending deep within the dendrimer highlighting the poor packing of the dendrons around the POSS core.

Solubility

The solubility of SCMP1 and the reference dendritic polymers was found to be as follows:

TABLE 2
Solubility of the dendritic polymers in various solvents

| | solvent^{[a]} | | | | | | | | |
|---|---|---|---|---|---|---|---|---|---|
| | toluene | m-xylene | chlorobenzene | CH₂Cl₂ | CHCl₃ | THF | DMF^{[b]} | DMA^{[c]} | DMSO ^{[d]} |
| SCMP1 | + + | + + | + + | + + | + + | + + | + + | + + | − |
| POSS-dend-1 | + | + | + | + + | + + | + + | − | − | − |
| POSS-dend-2 | + | + | + | + + | + + | + + | | + | − |

^{[a]}Solubility: fully soluble at room temperature (+ +); soluble under gentle heating (+); insoluble at room temperature (−)
^{[b]}DMF—Dimethylformamide;
^{[c]}DMA—N,N-Dimethylacetamide;
^{[d]} DMSO—Dimethyl sulfoxide.

Absorption and Photoluminescence Spectra.

Spectra for the dendrons, dendritic polymers and hyperbranched SCMPs were recorded at room temperature in optically dilute solutions Solvents were not degassed. THF was the main solvent used in this work. Dichloromethane (DCM, CH₂Cl₂) was also used to look for solvatochromic effects. No significant differences were observed in terms of spectra recorded In these two solvents.

Absorption spectra are shown in FIG. 13.

Notes for FIG. 13:

1) The absorption peaks at 282-286 nm for the dendrons, 6, 7, and the two dendrimers, POSS-dend-1 and POSS-dend-2, are assigned to vinyibiphenyl structure (λₘₐₓ=278 nm) and the characteristic vibration pattern of pyrene groups. SCMP1 shows vibrations for pyrene groups in this range.

2) The absorption at 310-386 nm is due to pyrene groups, however, extension of π-derealization is observed for SCMP1 with an unresolved shoulder at ˜400 nm.

3) When compared with the dendrons, 6 and 7, the absorbance peaks of POSS-dend-1 and POSS-dend-2 show no bathochromic shifts.

Fluorescence spectra are shown in FIG. 14.

Notes for FIG. 14:

1) The broad emission bands for SCMP1 and the dendrimers POSS-dend-1 and POSS-dend-2 at λₑₘ=478 nm, 460 nm, and 436 nm, respectively, reflect intramolecular interactions between the pyrene units in dilute THF solutions. POSS-dend-1 and POSS-dend-2 exhibit blue emissions while SCMP1 shows a green emission due to its more extended conjugation length.

2) POSS-dend-1 exhibits vibronic structures at 384 nm, typical for chromophore 6, and a bathochromic shift of 24 nm compared with POSS-dend-2. The emission intensity of POSS-dend-1 is weaker than POSS-dend-2 at the same concentration (by weight).

3) Once dendron 7 has been grafted onto the silsesquioxane core to form POSS-dend-2, the absorption and photoluminescence spectra show slight variations, probably indicating that the additional bulky groups in the dendrons (shown in FIG. 4b) introduce conformational and environmental effects on the chromophores.

Electron Microscopy:

Imaging of the crystal morphology was achieved using a Hitachi S-4800 cold Field Emission Scanning Electron Microscope (FE-SEM) operating in scanning modes. Samples were prepared by depositing dry crystals on 15 mm Hitachi M4 aluminum stubs using an adhesive high purity carbon tab before coating with a 2 nm layer of gold using an Emitech K550X automated sputter coater. Imaging was conducted at a working distance of 8 mm and a working voltage of 3 kV using a mix of upper and lower secondary electron detectors.

Gas Sorption Analysis.

Surface areas were measured by nitrogen adsorption and desorption at 77.3 K. Powder samples were degassed offline at 110° C. for 15 h under dynamic vacuum (10⁻⁵ bar) before analysis. Isotherms were measured using Micromeritics 2020, or 2420 volumetric adsorption analyzer.

Precipitation Conditions Study and Sorption Analysis:

A high-throughput screening method was used to assess the effect of various precipitation conditions. Solutions were mixed using an Eppendorf epMotion 5075 automated dispenser, and Nitrogen 5 point BET surface areas, at 77 K, were recorded using Quantachrome Nova® series Surface Area Analysers. The general procedure for each sample was the same, and the polymer was dissolved in good solvent (DCM) before precipitation into an anti-solvent. The factors investigated were: (i) anti-solvent volume, (ii) solvent removal method, (iii) anti-solvent choice, and (iv) rate of addition.

(i) Anti-solvent volume: 80 mg of SCMP1 dissolved in 1 mL DCM was added, at a rate of 1 mL/min, to methanol anti-solvent. Precipitated material was then centrifuged at 5,000 R.P.M. for 5 minutes and separated from the supernatant by decanting, before surface area analysis. Because changes in the volume of anti-solvent used were not found to have a significant effect on the surface area, or on the mass of the product recovered (see FIGS. 16 and 17), the lowest tested volume, of 10 mL, was used for the rest of this study.

(ii) Solvent removal method: 80 mg of SCMP1 dissolved in 1 mL DCM was added, at a rate of 1 mL/min, to 10 mL methanol anti-solvent. Precipitated material was then either: a) centrifuged at 5000 r.p.m. for 5 minutes and separated from the supernatant by decanting, b) naturally evaporated to dryness at room temperature in an open vessel, or c) rotary evaporated to dryness under dynamic vacuum at 40° C. As centrifuge separation was found to be most successful in producing the highest surface area (see FIG. 18), this method was used for the rest of the study.

(iii) Antisolvent choice: 80 mg of SCMP1 dissolved in 1 mL DCM was added, at a rate of 1 mL/min, to a range of different anti-solvents (10 mL). Precipitated material was then centrifuged at 5000 r.p.m. for 5 minutes and separated from the supernatant by decanting, before surface area analysis. The nature of anti-solvent used has a marked effect on the surface area of the material caused to precipitate (see FIG. 19), with apparent BET surface areas ranging from 0 m²/g up to ˜500 m²/g. For ease of use, because it is volatile and readily removed, petroleum ether was chosen as the standard anti-solvent for more detailed investigations.

(iv) Rate of addition: 80 mg of SCMP1 dissolved in 1 mL DCM was added, at varied rates of addition, to petroleum ether (10 mL). Precipitated material was then centrifuged at 5000 r.p.m. for 5 minutes and separated from the supernatant by decanting, before surface area analysis. The rate of addition, at least over the range studied, was not found to have a significant effect on the surface area (see FIG. 20).

POSS-Dendrimer Control Tests:

Precipitation: POSS-dendrimer samples were dissolved in DCM (1 mL) at 80 mg/mL concentration before being added dropwise to petroleum ether b.p. 40-60° C. (10 mL,). The resulting precipitated material was separated by centrifugation for 5 minutes at 5000 r.p.m. before the supernatant was decanted.

Further Examples of Hyperbranched Polymers

Materials: All reagents, solvents and compounds 8, 10, 12 and 16, 20, 24 and 26 were purchased from Aldrich except for compound 23 , which was purchased from TCI UK Fine Chemicals. Compounds 14^{[15]}, 15^{[15]} and 18^{[16]}, 21^{[13]}, 22^{[14]}, and 25^{[10]} were synthesized according to literature procedures. All reactions were carried out under a nitrogen or argon atmosphere. Triethylamine was dried over activated 4 Å molecular sieves. Toluene was dried over CaH₂ or sodium/benzophenone and distilled immediately prior to use and degased by freeze-pump-thaw or by bubbling with argon. Thin layer chromatography (TLC) was performed using pre-coated aluminum sheets with silica gel 60 F₂₅₄ (Merck) and visualized by UV light (λ=254 or 280 nm). Merck silica gel 60 was used for column chromatograph. Solution ¹H NMR spectra were collected on a Bruker UXNMR/XWIN-NMR 400 MHz spectrometer. Gel permeation chromatography (GPC) utilize a LC 1120 HPLC pump, a PL-ELS 1000 Evaporative Light Scattering Detector, a PL gel 5 μm MIXED-C GPC column and Midas autosampler (Polymer Laboratories Ltd. UK). THF was used as the eluent with flow rate of 1.00 mL/min at 40° C. and polystyrene as the standard.

Polymers HBP-B and HBP-C

Polymers HBP-B and HBP-C were prepared, as detailed below, in a similar manner to SCMP1. They further exemplify the use TMS or tert-butyl groups to provide polymers with good porosities.

Synthesis of Hyperbranched Polymer HBP-B:

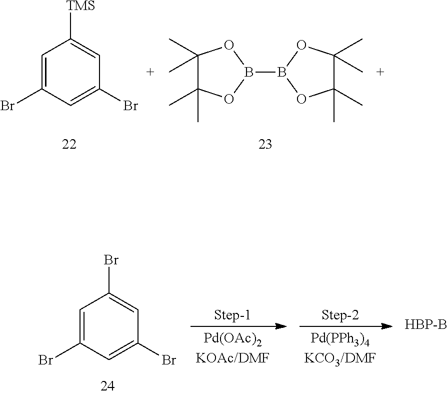

To an oven-dried 50 ml round-bottom flask equipped with a reflux condenser, under a nitrogen atmosphere, were charged compound 22 (924.3 mg g, 3.0 mmol), compound 23 (1.52 g, 6.0 mmol), compound 24 (629.6 mg, 2.0 mmol), palladium acetate Pd(OAc)₂ (72 mg, 0.3 mmol), potassium acetate KOAc (883 mg, 9.0 mmol), and anhydrous DMF (30 ml). After the mixture was degassed, it was heated and stirred at 90° C. for 20 h. After the above mixture was cooled down to room temperature, Pd(PPh₃)₄ (130 mg, 0.11 mmol), K₂CO₃ (972 mg, 7.0 mmol) and H₂O (3 ml) were added and degassed, it was heated to 120° C. and stirred for 90 h under a nitrogen atmosphere. After cooling down to room temperature, the mixture was diluted with dichloromethane (DCM), washed with 20% HCl solution, brine, water, respectively, and dried over MgSO₄. The organic layer was filtered and evaporated to dryness. The crude product was dissolved in dichloromethane and filtered off with 0.2 μm syringe filter, followed by precipitation into methanol and dried at 150° C. to give a off-white powder (320 mg) in 53% yield. GPC analysis: Mw=8423 g/mol, Mₙ=3001 g/mol and PD=2.8; ¹H NMR (400 MHz: CDCl₃; ppm) δ: ¹H NMR (400 MHz, CDCl₃): 8.22-7.35 (m, aromatic-H), 0.85 (br, -TMS), 0.32 (br, -TMS). (Calc. ratio of proton based on -TMS and Aromatic=1.8, found, 1.4).

Synthesis of Hyperbranched Polymer HBP-C:

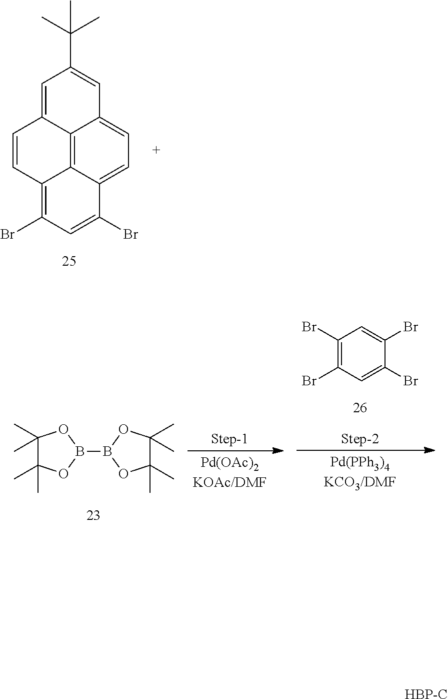

To an oven-dried 50 ml round-bottom flask equipped with a reflux condenser, under a nitrogen atmosphere, were charged compound 25 (207 mg, 0.5 mmol), compound 23 (391 mg, 1.5 mmol), palladium acetate Pd(OAc)₂ (12 mg, 0.05 mmol), potassium acetate KOAc (265 mg, 2.70 mmol), and anhydrous DMF (25 ml). After the mixture was degassed, it was heated and stirred at 90° C. for 5 h. After the above mixture was cooled down to room temperature, compound 26 (98 mg, 0.25 mmol), Pd(PPh₃)₄ (34 mg, 0.03 mmol), and K₂CO₃ (212 mg, 1.53 mmol) were added and degassed, it was heated to 110° C. and stirred for 72 h under a nitrogen atmosphere. After cooling down to room temperature, the mixture was diluted with dichloromethane (DCM), washed with 20% HCl solution, brine, water, respectively, and dried over MgSO₄. The organic layer was filtered and evaporated to dryness. The crude product was dissolved in dichloromethane and filtered off with 0.2 μm syringe filter, followed by precipitation into methanol and dried at 150° C. to give a brownish powder (114 mg) in 32% yield. GPC analysis: Mw=2875 g/mol, Mₙ=2211 g/mol and PD=1.3; ¹H NMR (400 MHz; CDCl₃; ppm) δ: ¹H NMR (400 MHz, CDCl₃): 8.23-7.95 (m, aromatic-H), 1.58-1.12 (m, t-Butyl). (Calc. ratio of proton based on Aromatic, and t-Butyl=0.88, found, 0.50).

Properties of HBP-B and HBP-C are shown in the following table:

TABLE 3

| Sample | Mw | Mn | PDI | BET (m²/g) |
|---|---|---|---|---|
| HBP-B | 8423 | 3001 | 2.8 | 373 |
| HBP-C | | | | 380 |

Polymers Prepared by Metal Free Diels-Alder Addition

Hyperbranched conjugated polymers were prepared by metal free Diels-Alder routes. The polymers are designated below as CG-HPP5, CG-Poly DPP, CG-HBPAB, CG-LPy-16A and CG-LPy-20. Their syntheses, and the syntheses of their precursors, are as follows:

Synthesis of Compound 9

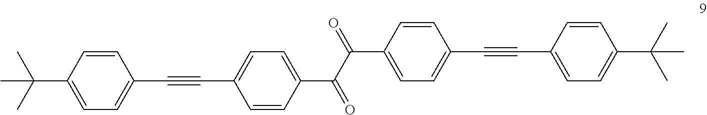 [SMILES: CC(C)(C)c1ccc(C#Cc2ccc(C(=O)C(=O)c3ccc(C#Cc4ccc(C(C)(C)C)cc4)cc3)cc2)cc1]

To an oven-dried 100-mL flask equipped with a condenser and a magnetic stirring bar were charged monomer 20 (2.0 g, 5.43 mmol), Pd(PPh₃)₂Cl₂ (191 mg, 0.27 mmol), PPh₃ (143 mg, 0.53 mmol), CuI (103 mg, 0.53 mmol), toluene (20 mL) and triethylamine (Et₃N) (40 mL). After it was degassed and had been heated with stirring at 60° C. for 15 min, then compound 8 (2.3 g, 14.4 mmol) was added and the mixture was stirred at 90° C. for 48 h. After the usual work-up, the crude product was purified by column chromatography on silica gel, eluting with DCM/petroleum ether (40-60° C.) (15%) to give 2.55 g yellow powder in 90% yield. ¹H NMR (400 MHz, CDCl₃) δ 7.96 (d, J=8.8 Hz, 4H), 7.64 (d, J=8.4 Hz, 4H), 7.44 (q_{AB}, J=38.8 Hz, 8.4 Hz, 8H), 1.33 (s, 18H); ¹³C NMR (75 MHz, CDCl₃) δ 193.33, 152.53, 132.00. 131.76, 131.62, 130.53, 129.85, 125.52, 119.35, 94.56, 87.98, 34.91, 31.15.

Synthesis of Compound 11

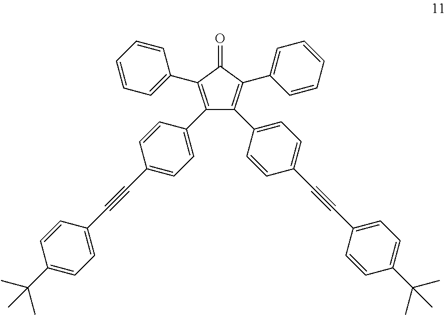 [SMILES: CC(C)(C)c1ccc(C#Cc2ccc(C3=C(c4ccccc4)C(=O)C(c4ccccc4)=C3c3ccc(C#Cc4ccc(C(C)(C)C)cc4)cc3)cc2)cc1]

A solution of potassium hydroxide (75 mg, 1.34 mmol) in ethanol (4 ml.) was added to a solution of 9 (783 mg, 1.5 mmol) and 10 (630 mg, 1.5 mmol) in ethanol (20 mL) at 80° C., and the reaction was refluxed for 4 hours. Water (50 mL) and dichloromethane (100 mL) were added, and the layers were separated. The organic layer was washed with brine and dried over magnesium sulfate. The solvent was removed to leave a dark purple solid. The crude product was purified by column chromatography on silica gel, eluting with DCM/petroleum ether (40-60° C.) (20%) to give 11 as a brown crystalline solid (856 mg) in 82% yield. ¹H NMR (400 MHz, CDCl₃) δ 7.44 (d, J=8.4, 4H), 7.35 (m, 8H), 7.26 (m, 10H), 6.92 (d, J=8.4 Hz, 4H); ¹³C NMR (75 MHz, CDCl₃) δ 199.81, 153.38, 151.84, 132.62, 131.38, 131.28, 130.48, 130.17, 129.46, 128.18, 127.72, 125.75, 125.41, 123.84, 119.90, 91.16, 88.44, 34.84, 31.17.

Synthesis of Compound 13

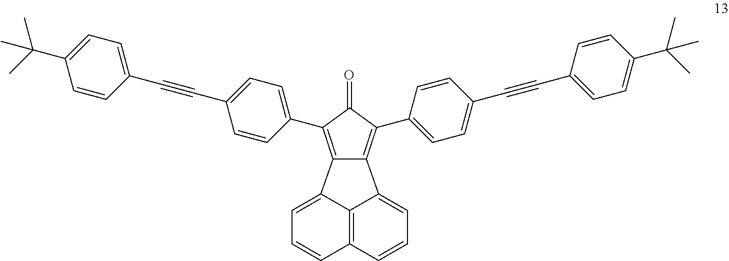 [SMILES: CC(C)(C)c1ccc(C#Cc2ccc(C3=C4C(=C(c5ccc(C#Cc6ccc(C(C)(C)C)cc6)cc5)C3=O)c3cccc5cccc4c35)cc2)cc1]

A solution of potassium hydroxide (119 mg, 2.1 mmol) in ethanol (2 mL) was added to a solution of 9 (155 mg, 0.296 mmol) and 12 (57 mg, 0.313 mmol) in ethanol (10 mL) at 80° C., and the reaction was refluxed for 4 hours. The reaction mixture was cooled to 0° C. and the dark green solid was filtered, washed with ethanol and dried to give a crystalline solid (158 mg) in 80% yield; ¹H NMR (400 MHz, CDCl₃) δ7.80 (d, J=7.2 Hz, 2H), 7.62 (d, J=8.0 Hz, 2H), 7.56 (d, J=8.0 Hz, 4H), 7.40 (d, J=8.0 Hz, 4H), 7.34 (d, J=8.0 Hz, 2H), 7.24 (ds J=8.4 Hz, 4H), 7.13 (d, J=8.4 Hz, 4H), 1.08 (s, 18H); ¹³C NMR (75 MHz, CDCl₃) δ 201.24, 154.61, 151.71, 132.15, 131.75, 131.42, 131.34, 131.10, 128.95, 128.51, 128.03, 125.41, 123.39, 121.26, 121.18, 120.19, 91.02, 88.33, 34.84, 31.20.

Synthesis of Compound 17

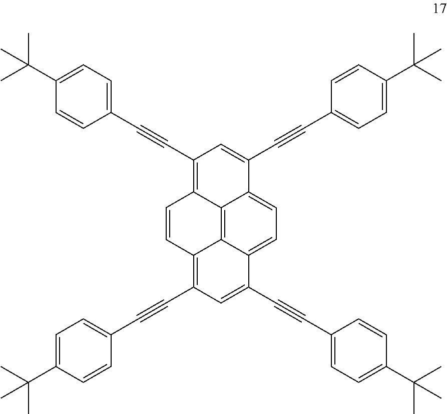 [SMILES: CC(C)(C)c1ccc(C#Cc2cc(C#Cc3ccc(C(C)(C)C)cc3)c3ccc4c(C#Cc5ccc(C(C)(C)C)cc5)cc(C#Cc5ccc(C(C)(C)C)cc5)c5ccc2c3c54)cc1]

To an oven-dried 100-mL flask equipped with a condenser and a magnetic stirring bar were charged monomer 16 (517.83 mg, 1.0 mmol), Pd(PPh₃)₂Cl₂ (214 mg, 0.20 mmol), PPh₃ (105.6 mg, 0.40 mmol), CuI (74.25 mg, 0.40 mmol), toluene (10 mL) and triethylamine (Et₃N) (25 mL). After it was degassed and had been heated with stirring at 60° C. for 15 min, then 4-tert-butylphenylacetylene 8 (1.26 g, 8.0 mmol) was added and the mixture was stirred at 90° C. for 48 h, After the usual work-up, the crude product was purified by column chromatography on silica gel, eliding with petroleum ether (40-60° C.), followed by 10% dichloromethane in petroleum ether (40-60° C.) to give a light yellow powder (310 mg) in 60% yield, ¹H NMR (400 MHz, CDCl₃) δ 8.68 (s, 4H), 8.68 (s, 2H), 7.67 (d, J=8.4 Hz, 8H), 7.46 (d, J=8.4 Hz, 8H), 1.38 (s, 36H); ¹³C NMR (75 MHz, CDCl₃) δ 152.39, 131.96, 127.04, 125.95, 120.70, 119.42, 96.62, 87.59, 35.31, 31.63.

Synthesis of Compound 19

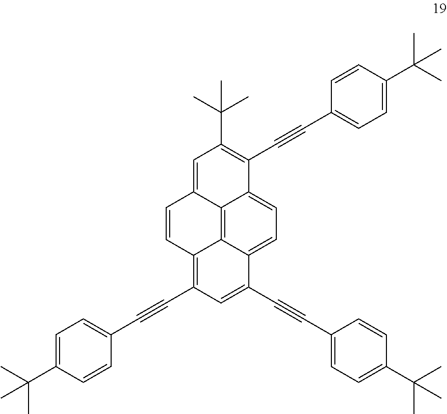 [SMILES: CC(C)(C)c1ccc(C#Cc2c(C(C)(C)C)cc3ccc4c(C#Cc5ccc(C(C)(C)C)cc5)cc(C#Cc5ccc(C(C)(C)C)cc5)c5ccc2c3c45)cc1]

To an oven-dried 100-mL flask equipped with, a condenser and a magnetic stirring bar were charged monomer 18 (502 mg, 1.0 mmol), Pd(PPh₃)₂Cl₂ (105 mg, 0.15 mmol), PPh₃ (78.7 mg, 0.30 mmol), CuI (57.12 mg, 0.30 mmol), toluene (20 mL) and triethylamine (Et₃N) (15 mL). After it was degassed and had been heated with stirring at 60° C. for 15 min, then 4-tert-butylphenylacetylene 8 (1.00 g, 6.25 mmol) was added and the mixture was stirred at 90° C. for 48 h. After the usual work-up, the crude product was purified by column chromatography on silica gel, eluting with petroleum ether (40-60° C.), followed by 10% dichloromethane in petroleum ether (40-60° C.) to give a light yellow powder (218 mg) in 30% yield. ¹H NMR (400 MHz, CDCl₃) δ 8.96 (d, J=9.2 Hz, 1H), 8.71 (d, J=9.6 Hz, 1H), 8.63 (d, J=9.2 Hz, 1H), 8.39 (s, 1H), 8.27 (s, 1H), 8.13 (d, J=92 Hz, 1H), 7.67 (m, 6H), 7.47 (m, 6H), 1.85 (s, 9H), 1.37 (s, 27H).

Synthesis of Hyperbranched Polymer CG-HPP5:

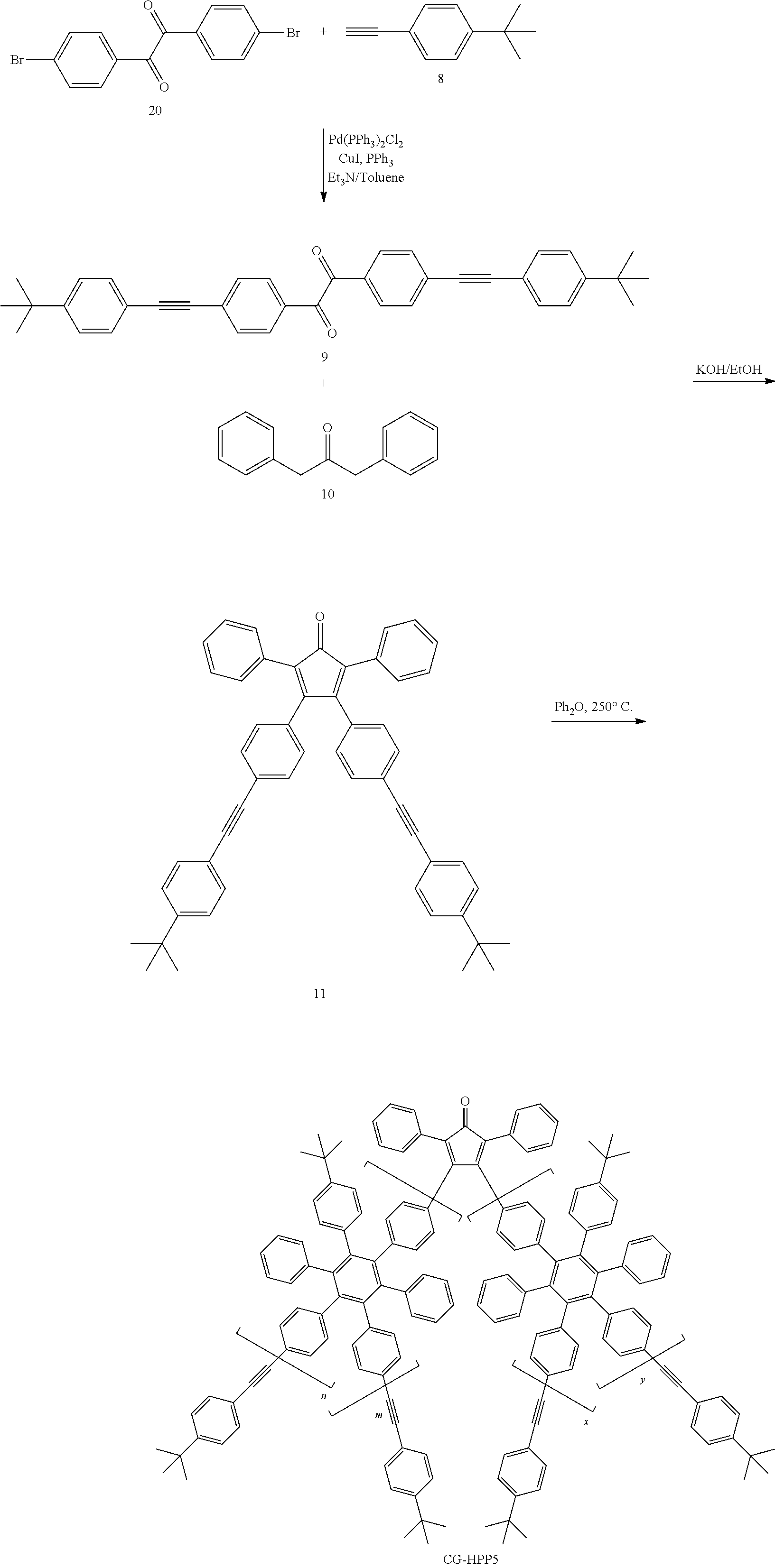

To a Schlenk tube were charged with monomer 11 (326 mg, 0.47 mmol) and diphenyl ether (1.5 mL). After the mixture was degassed, it was stirred for 5 d at 250° C. After cooling down to room temperature, it was diluted with dichloromethane (DCM) (1.5 mL), the polymer was recovered by precipitation into methanol (40 mL). The crude product was dissolved in dichloromethane (DCM) (3 mL) and absorbed on silica gel and fully air dried, followed by washing with Soxhlet extraction with hot hexane for overnight. Then it was recovered by Soxhlet extraction with dichloromethane (DCM) for 24 h. The obtained solution was concentrated and filtered off with 0.2 μm syringe filter, followed by precipitation into methanol. The polymer product was isolated by centrifugation and dried in vacuum at 150° C. to give a off-white powder (219 mg) in 70% yield. GPC analysis: Mw=24600 g/mol, Mₙ=19767 g/mol and PD=1.24; ¹H NMR (400 MHz; CDCl₃; ppm) δ: ¹H NMR (400 MHz, CDCl₃): 7.61-7.28 (m, aromatic-H), 7.06-6.53 (m, aromatic-H), 6.22-6.14 (m, aromatic-H), 1.59-1.52 (m, t-Butyl), 1.32-1.08 (m, t-Butyl). (Calc. ratio of proton based on Aromatic, and t-Butyl=1.44, found, 1.25).

Synthesis of Hyperbranched Polymer CG-Poly DPP:

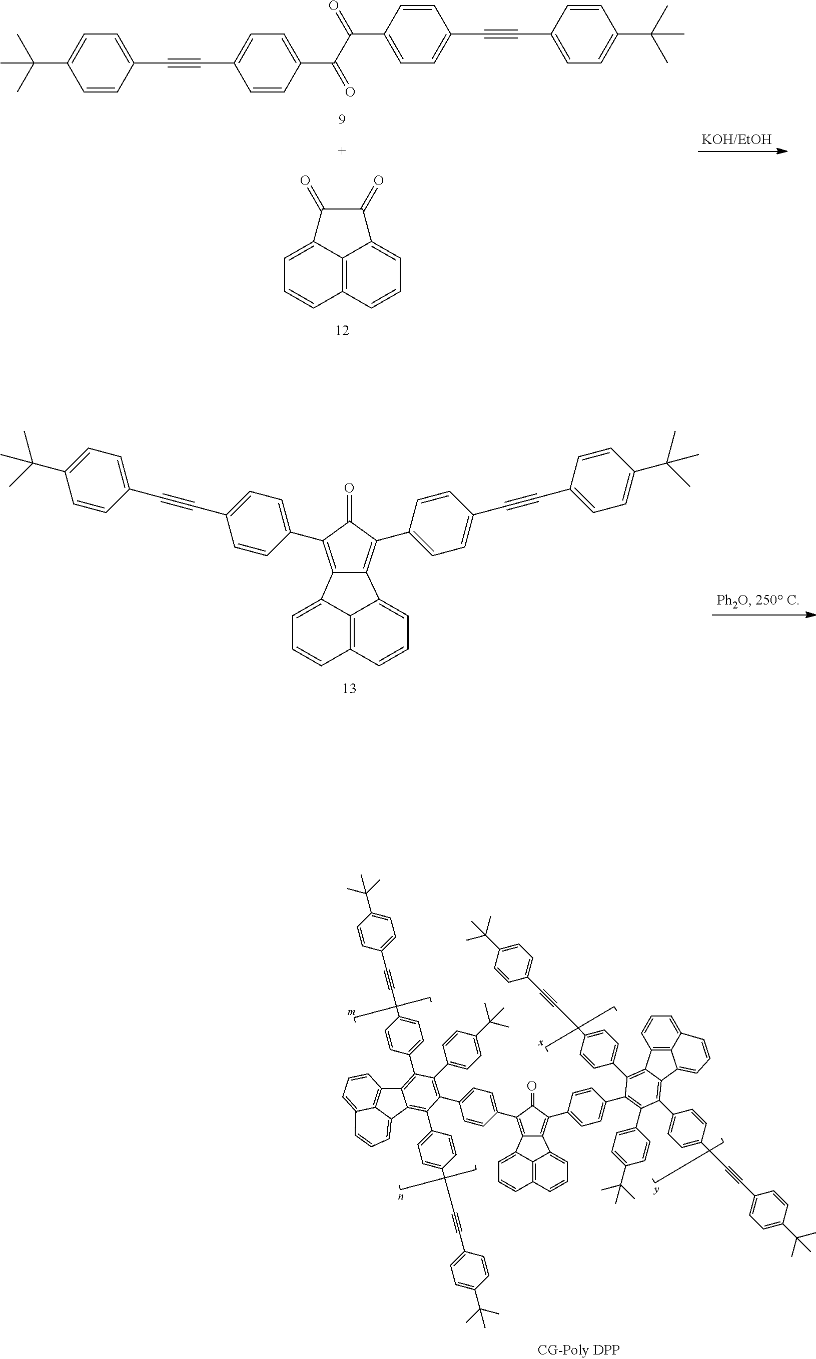

To a Schlenk tube were charged with monomer 13 (158 mg, 0.24 mmol) and diphenyl ether (1.5 mL). After the mixture was degassed, it was stirred for 7 d at 250° C. After cooling down to room temperature, it was diluted with dichloromethane (DCM) (1.5 mL), the polymer was recovered by precipitation into methanol (40 mL). The crude product was dissolved in dichloromethane (DCM) (3 mL) and absorbed on silica gel and fully air dried, followed by washing with Soxhlet extraction with hot hexane for overnight. Then it was recovered by Soxhlet extraction with dichloromethane (DCM) for 24 h. The obtained solution was concentrated and filtered off with 0.2 μm syringe filter, followed by precipitation into methanol. The polymer product was isolated by centrifugation and dried in vacuum at 150° C. to give a yellow powder (98 mg) in 65% yield. GPC analysis: Mw=5075 g/mol, Mₙ=3828 g/mol and PD=1.33; ¹H NMR (400 MHz; CDCl₃; ppm) δ: ¹H NMR (400 MHz, CDCl₃): 7.74-6.67 (m, aromatic-H), 1.55-0.88 (m, t-Buryl) (Calc. ratio of proton based on Aromatic, and t-Butyl=1.22, found, 1.16).

Synthesis of Hyperhranched Polymer CG-HBPAB:

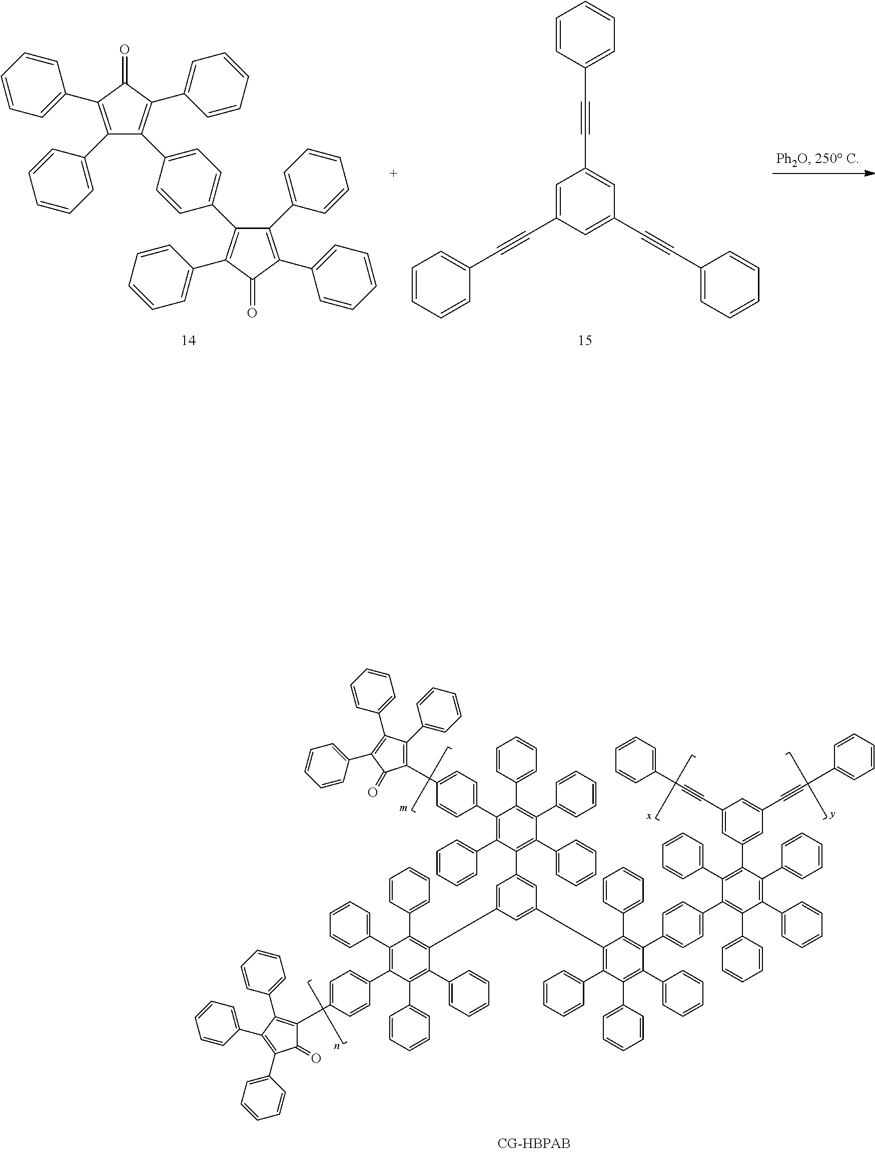

To a Schlenk tube were charged with, monomer 14 (207 mg, 0.30 mmol), monomer 15 (76 mg, 0.20 mmol) and diphenyl ether (1.7 mL). After the mixture was degassed, it was stirred for 96 h at 250° C. After cooling down to room temperature, it was diluted with dichloromethane (DCM) (1.5 mL), the polymer was recovered by precipitation into methanol (40 mL). The crude product was dissolved in dichloromethane (DCM) (3 mL) and absorbed on silica gel and fully air dried, followed by washing with Soxblet extraction with hot hexane for overnight. Then it was recovered by Soxhlet extraction with dichloromethane (DCM) for 24 h. The obtained solution was concentrated and filtered off with 0.2 μm syringe filter, followed by precipitation into methanol. The polymer product was isolated by centrifegation and dried in vacuum at 150° C. to give a light brown powder (170 mg) in 64% yield. GPC analysis: Mw=40493 g/mol, Mₙ=10780 g/mol and PD=3.76; ¹H NMR (400 MHz; CDCl₃; ppm) δ: ¹H NMR (400 MHz, CDCl₃): 7.42-6.13 (m, aromatic-H).

Synthesis of Hyperbranched Polymer CG-LPy-16A:

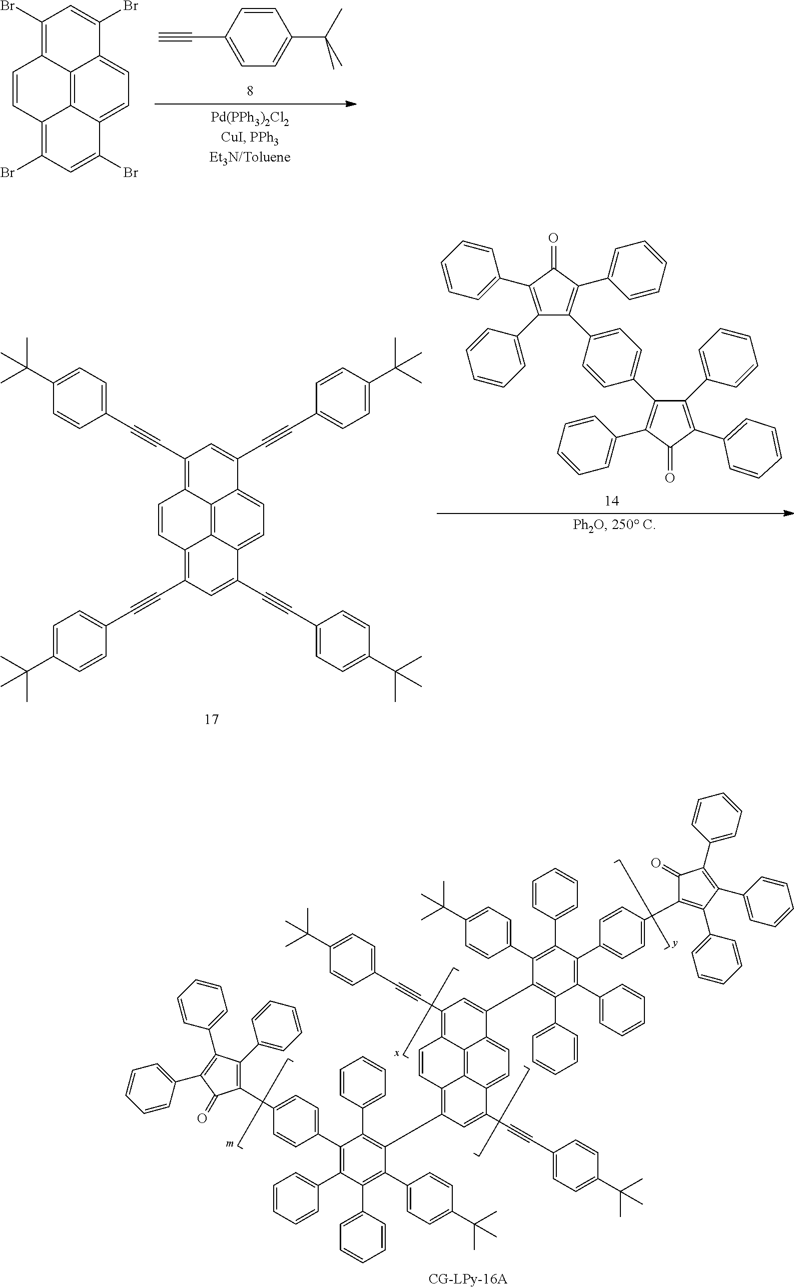

To a Schlenk tube were charged with monomer 17 (95 mg, 0.115 mmol), monomer 14 (158.70 mg, 0.23 mmol) and diphenyl ether (2.0 mL). After the mixture was degassed, it was stirred for 48 h at 250° C. After cooling down to room temperature, it was diluted with dichloromethane (DCM) (1.5 mL), the polymer was recovered by precipitation into methanol (40 mL). The exude product was dissolved in dichloromethane (DCM) (3 mL) and absorbed on silica gel and fully air dried, followed by washing with Soxhlet extraction with hot hexane for overnight. Then it was recovered by Soxhlet extraction with dichloromethane (DCM) for 24 h. The obtained solution was concentrated and filtered off with 0.2 μm syringe filter, followed by precipitation into methanol. The polymer product was isolated by centrifugation and dried in vacuum at 150° C. to give a brown powder (103 mg) in 43% yield. GPC analysis: Mw=135407 g/mol, Mₙ=44415 g/mol and PD=3.05; ¹H NMR (400 MHz, CDCl₃): 8.32-6.86 (m, aromatic-H), 1.56-0.74 (m, t-Butyl) (Calc. ratio of proton based on Aromatic, and t-Butyl=2.5, found, 2.04).

Synthesis of Hyperbranched Polymer CG-LPy-20:

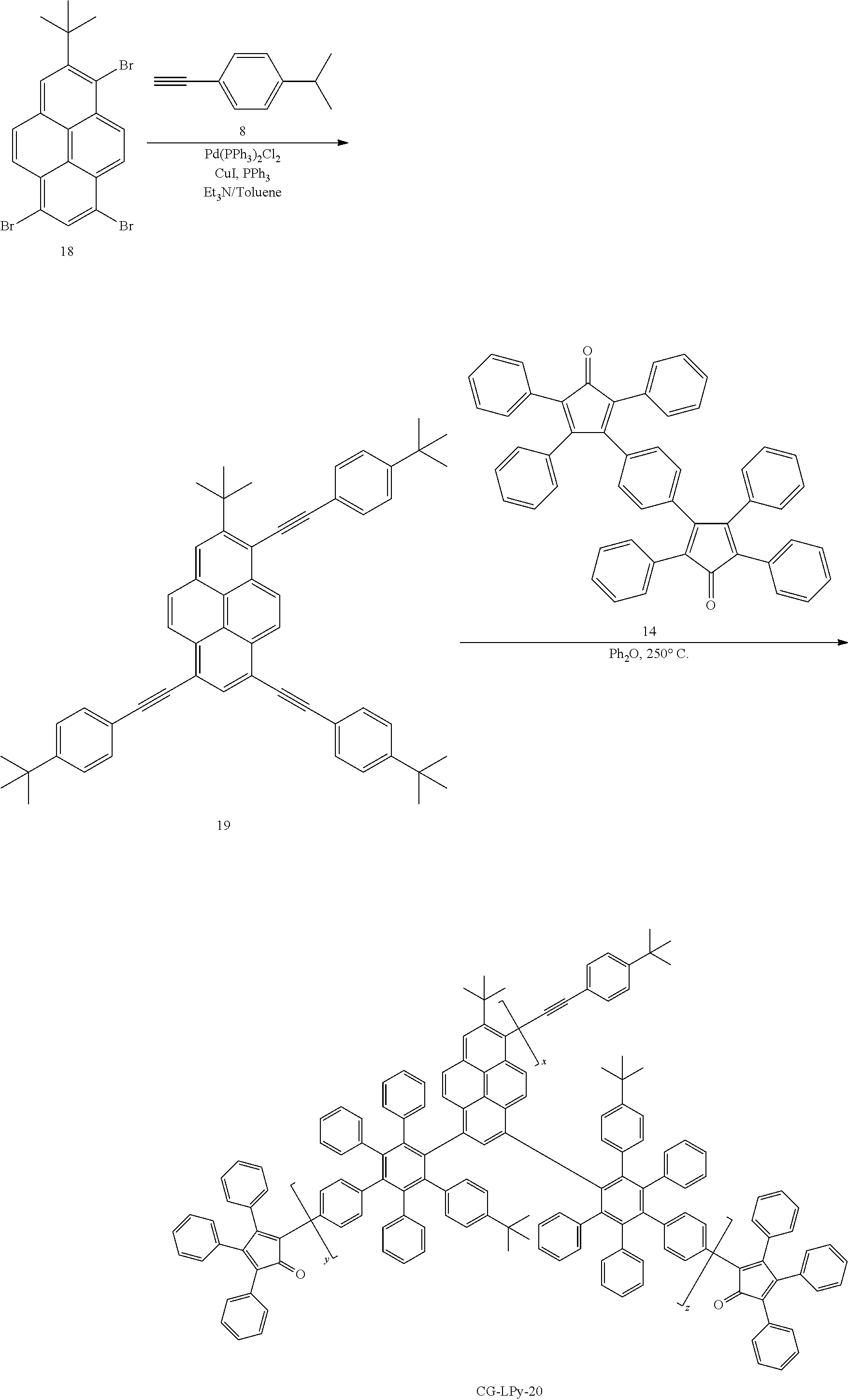

To a Schlenk tube were charged with monomer 19 (87 mg, 0.12 mmol), monomer 14 (124 mg, 0.18 mmol) and diphenyl ether (1.5 mL). After the mixture was degassed, it was stirred for 96 h at 250° C. After cooling down to room temperature, it was diluted with dichloromethane (DCM) (1.5 mL), the polymer was recovered by precipitation into methanol (40 mL). The crude product was dissolved in dichloromethane (DCM) (3 mL) and absorbed on silica gel and fully air dried, followed by washing with Soxhlet extraction with hot hexane for overnight. Then it was recovered by Soxhlet extraction with dichloromethane (DCM) for 24 h. The obtained solution was concentrated and filtered off with 0.2 μm syringe filter, followed by precipitation into methanol. The polymer product was isolated by centrifugation and dried in vacuum at 150° C. to give a light brown powder (130 mg) in 68% yield. GPC analysis: Mw=5052 g/mol, Mₙ=3899 g/mol and PD−1.30; ¹H NMR (400 MHz, CDCl₃): 8.22-6.37 (m, aromatic-H), 1.68-0.80 (m, t-Butyl) (Calc. ratio of proton based on Aromatic, and t-Butyl=1.92, found, 1.78).

Properties of the polymers are shown in the following table:

TABLE 4

| Sample | M_{w} (g mol⁻¹) | Mₙ (g mol⁻¹) | PDI | BET (m² g⁻¹) |
|---|---|---|---|---|
| CG-Poly DPP | 5075 | 3828 | 1.33 | 264 |
| CG-HPP5 | 24600 | 19767 | 1.24 | 363 |
| CG-HBPAB | 40493 | 10780 | 3.76 | 474 |
| CG-LPy-16A | 135407 | 44415 | 3.05 | 447 |
| CG-LPy-20 | 5052 | 3899 | 1.30 | 462 |

### REFERENCES

[1] a) J. X. Jiang, F. Su, A. Trewin, C. D. Wood, N. L. Campbell, H. Niu, C. Dickinson, A. Y. Ganin, M. J. Rosseinsky, Y. Z. Khimyak, A. I. Cooper, Angew. Chem. In. Ed. 2007, 46, 8728-8732; b) J. Weber, A. Thomas, J. Am. Chem. Soc. 2008, 130, 6334-6335; e) J. X. Jiang, F. Su, A. Trewin, C. D. Wood, H. Niu, J. T. A. Jones, Y. Z. Khimyak, A. I. Cooper, J. Am. Chem. Soc. 2008, 130, 7710-7720; d) A. I. Cooper, Adv. Mater. 2909, 21, 1291-1295; e) R. Dawson, A. Layboum, R. Clowes, Y. Z, Khimyak, D. J. Adams, A. I. Cooper, Macromolecules 2009, 42, 8809-8816; f) J. Schmidt, M. Werner, A. Thomas, Macromolecules 2009, 42, 4426-4429; g) L. Chen, Y. Honsho, S. Seki, D. L. Jiang, J. Am. Chem. Soc. 2010, 132, 6742-6748; h) L. Chen, Y. Yang, D. L. Jiang, J. Am. Chem. Soc. 2010, 132, 9138-9143; i) J. X. Jiang, C. Wang, A. Laybourn, T. Hasell, R. Clowes, Y. Z. Khimyak, J. L. Xiao, S. J. Higgins, D. J. Adams, A. I. Cooper, Angew. Chem. In. Ed. 2011, 50, 1072-1075; j) Y. Kou, Y. H. Xu, Z. Q. Guo, D. L. Jiang, Angew. Chem. In. Ed. 2011, 50, 8753-8757; k) R. Dawson, D. J. Adams, A. I. Cooper, Chem. Sci. 2011, 2, 1173-1177; l) Y. H. Xu, L. Chen, Z. Q. Guo, A. Nagai, D. L. Jiang, J. Am. Chem. Soc. 2011, 133, 17622-17625; m) A. Li, H. X. Sun, D. Z. Tan, W. J. Fan, S. H. Wen, X. J. Qing, G. X. Li, S. Y. Li, W. Q. Deng, Energy Environ. Sci 2011, 4, 2062-2065; n) X. Liu, Y. Xu, D. Jiang, J. Am. Chem. Soc. 2012, 134, 8738-8741
[2] a) M. Rose, W. Bohlmann, M. Sabo, S. Kaskel, Chem. Commun. 2008, 2462-2464; b) T. Ben, H. Ren, S. Q. Ma, D. P. Cao, J. H. Lan, X. F. Jing, W. C, Wang, J. Xu, F. Deng, J. M. Simmons, S. L. Qiu, G. S. Zhu, Angew. Chem. In. Ed. 2009, 48, 9457-9460; c) D. Yuan, W. Lu, D, Zhao, H.-C. Zhou, Adv. Mater. 2011, 23, 3723-3725; d) W. Lu, J. P. Sculley, D. Yuan, R. Krishna, Z. Wei, H.-C. Zhou, Angew. Chem. In. Ed. 2012, 51, doi: 10.1002/ange.201202176; e) Z. G. Xie, C. Wang, K. E. deKrafft, W. B. Lin, J. Am. Chem. Soc. 2011, 133, 2056-2059.
[3] P. M. Budd, B. S. Ghanem, S. Makhseed, N. B. McKeown, K. J. Msayib, C. E. Tattershall, Chem. Commun. 2094, 230-231.
[4] a) P. M. Budd, E. S. Elabas, B. S. Ghanem, S. Makhseed, N. B. MeKeown, K. J. Msayib, C. E. Tattershall, D. Wang, Adv. Mater, 2004, 16, 456-459; b) N. B. McKeown, P. M. Budd, Macromolecules 2010, 43, 5163-5176.
[5] P. Zhang, Z. Weng, J. Guo, C. Wang, Chem. Mater. 2011, 23, 5243-5249.
[6] a) F. Vilela, K. Zhang, M. Antonietti, Energy Environ. Sci. 2012, 5, 7819-7832; b) A. Thomas, Angew. Chem. In. Ed. 2010, 49, 8328-8344.
[7] a) Y. H. Kim, O. W. Webster, J. Am. Chem. Soc. 1990, 112, 4592-4593; b) Y. H. Kim, O. W. Webster, Macromolecules 1992, 25, 5561-5572.
[8] J. X. Jiang, A. Trewin, D. J. Adams, A. I. Cooper, Chem. Sci. 2011, 2, 1777-1781.
[9] L. Zhu, J. Duquette, M. B. Zhang, J. Org, Chem. 2903, 68, 3729-3732.
[10] T. M. Figueira-Duarte, S. C. Simon, M. Wagner, S. I. Drtezhinin, K. A. Zachariasse, K. Muellen, Angew. Chem. In. Ed. 2008, 47, 10175-10178.
[11] a) Y. Itami, B. Marciniec, M. Kubicki, Chem. Euro. J. 2004, 10, 1239-1248; b) G. Cheng, N. R. Vautravers, R. E. Morris, D. J. Cole-Hamilton, Org. Biomol. Chem, 2008, 6, 4662-4667.
[12] P. Andre, G. Cheng, A. Ruseckas, T. van Mourik, H. Fruechtl, J. A. Crayston, R. E. Morris, D. Cole-Hamilton, I. D. W. Samuel, J. Phys. Chem. B 2008, 112, 16382-16392.
[13] Y. H. Kim, O. W. Webster, J. Am. Chem. Soc., 1990, 112, 4592-4593.
[14] T. M. Miller, T. X. Neean, R. Zayas, H. E. Bair, J. Am. Chem. Soc., 1992, 114, 1018-1025.
[15] K. Stumpe, H. Komber, B. I. Voit, Macromolecular Chemistry and Physics 2006, 207, 1825-1833
[16] J. Inoue, K. FuKui, T. Kubo, S. Nakazawa, K. Sato, D. Shiomi, Y. Moria, K. Yamamoto, T. Takui, K. Nakasnji, J. Am. Chem. Soc. 2001, 123, 12702-12703.

1. A soluble conjugated microporous polymer.

2. A soluble conjugated microporous polymer according to claim 1 having a macromolecular structure comprising voids.

3. A polymer as claimed in claim 1 having a macromolecular structure comprising rigid moieties.

4. A polymer as claimed in claim 1 having a macromolecular structure comprising twisted moieties.

5. A polymer as claimed in claim 1 having a macromolecular structure comprising contorted moieties.

6. A polymer as claimed in claim 1 having a macromolecular structure comprising concave moieties.

7. (canceled)

8. A soluble conjugated microporous polymer as claimed in claim 1 comprising repeating units which are linked together to form a rigid macromolecular structure which does not exhibit space-efficient packing.

9. A soluble conjugated microporous polymer as claimed in claim 1 in the form of discrete restricted-growth polymer units.

10. A polymer as claimed in claim 1 which has a solubility of at least 0.05 g/mL.

11-12. (canceled)

13. A polymer as claimed in claim 1 which has a micropore volume of at least 0.1 cm³/g.

14-15. (canceled)

16. A polymer as claimed in claim 1, which has a BET surface area of at least 10 m²/g.

17. (canceled)

18. A polymer as claimed in claim 1 carrying one or more type of solubilizing group.

19. A microporous polymer comprising nodes and struts in conjugation with each other, wherein:
the nodes comprise one or more of an aromatic moiety and an unsaturated moiety;
the struts comprise one or more of a single bond, an unsaturated moiety, and an aromatic moiety; and
the polymer carries one or more solubilizing group.

20-23. (canceled)

24. A polymer as claimed in claim 1 wherein conjugation extends through at least three adjacent monomers.

25. A polymer as claimed in claim 1 wherein conjugation extends throughout the polymer.

26. A polymer as claimed in claim 19 wherein the solubilizing groups are selected from branched or linear alkyl chains, fluoroalkyl chains, silyl groups, alkyl ethers, oligoethyleneoxide, oligopropylene oxide, carboxylic acid groups, sulfonates, quaternary ammonium salts, imidizolium salts, or pyridinium salts.

27. A polymer as claimed in claim 26 comprising C3 to C10 branched alkyl groups.

28. A polymer as claimed in claim 26 comprising tertiary butyl groups.

29. A polymer as claimed in claim 26 comprising silyl groups.

30. A polymer as claimed in claim 26 comprising TMS groups.

31. A polymer as claimed in claim 26 comprising aromatic or heteroaromatic rings.

32. A polymer as claimed in claim 1 wherein the polymer comprises multiple fused aromatic and/or heteroaromatic ring structures.

33. A polymer as claimed in claim 1 comprising pyrene monomers or pyrene moieties.

34. A polymer as claimed in claim 33 wherein pyrene moieties are coupled to each other via single bonds.

35. A polymer as claimed in claim 33 wherein the pyrene moieties are coupled through some or all of their 1-, 3-, 6- or 8-positions.

36. A polymer as claimed in claim 33 which contains the following repeating monomeric unit:

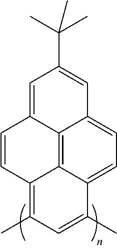

37. A polymer as claimed in claim 33 which contains the following repeating monomeric unit:

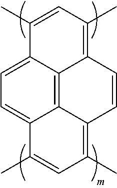

38. A polymer as claimed in claim 1 comprising aromatic rings which are multiply substituted with other aromatic rings.

39. A polymer as claimed in claim 38 comprising benzene rings multiply substituted with other benzene rings.

40. A polymer as claimed in claim 1 in the form of a film.

41. A method for preparing a soluble conjugated microporous polymer as claimed in claim 1 comprising polymerization or copolymerization of monomers.

42-48. (canceled)

49. A battery, separation device, electronic device, membrane, catalyst, photocatalytic apparatus, capacitor, or gas storage device comprising a polymer as claimed in claim 1.

50. A composite material or apparatus comprising a polymer as claimed in claim 1, for example a catalyst-embedded membrane, or a separation membrane in a battery or supercapacitor.

51. (canceled)
